(19) United States
(12) Patent Application Publication
(10) Pub. No.: US 2025/0056265 A1
(43) Pub. Date: Feb. 13, 2025

(54) INTERFERENCE REDUCTION BETWEEN WIRELESS COMMUNICATION DEVICES OF OVERLAPPING BASIC SERVICE SETS

(71) Applicant: QUALCOMM Incorporated, San Diego, CA (US)

(72) Inventors: Amol SAXENA, Bangalore (IN); Devangam Kotha KIRANKUMAR, Bengaluru (IN); Raj Kumar KRISHNA KUMAR, Bangalore (IN); Manikandan CHANDRASEKAR, Bangalore (IN); Abhijit BHATTACHARYA, Bangalore (IN); Srinivas PILLAPPAKKAM, Bangalore (IN); Rohit KAPOOR, Bangalore (IN)

(21) Appl. No.: 18/447,168

(22) Filed: Aug. 9, 2023

(51) Int. Cl. H04W 24/06; H04W 24/10

(52) U.S. Cl. CPC H04W 24/06; H04W 24/10

(57) ABSTRACT

This disclosure provides methods, components, devices and systems for interference reduction between wireless communication devices of overlapping basic service sets (OBSSs). Some aspects more specifically relate to signaling mechanisms associated with an OBSS channel sounding operation and power control mechanisms associated with OBSS interference mitigation, either or both of which a first access point (AP) associated with a first basic service set (BSS) may leverage as part of a coordinated beamforming scheme with a second AP associated with a second BSS. In accordance with OBSS channel sounding, the first AP may associate a set of sounding packets with one or more parameters indicative of the second BSS such that the sounding packets appear, to OBSS stations (STAs), as in-BSS sounding packets. Additionally, or alternatively, the first AP may employ a power control mechanism according to which the first AP may apply portion-by-portion transmission power control.

### TECHNICAL FIELD

This disclosure relates to wireless communication and, more specifically, to interference reduction between wireless communication devices of overlapping basic service sets (OBSSs).

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

In an example WLAN, a first AP managing a first BSS may exchange one or more packets as part of a channel sounding operation with one or more STAs also in the first BSS (referred to as in-BSS STAs). For example, the first AP may transmit a null data packet (NDP) announcement (NDPA) frame having a transmitter address (TA) field that indicates the TA of the first AP. One or more STAs of the first BSS having receive addresses (RAs) and/or association identifiers (AIDs) indicated in the NDPA frame may recognize the NDPA and prepare to receive one or more subsequent NDPs. The first AP may transmit the NDPs and each addressed STA may measure a respective channel between the first AP and that STA. The one or more STAs may transmit results of their respective channel measurements to the first AP via a coordinated beamforming (CBF) report. The first AP may select one or more transmission parameters in accordance with the channel measurement results and communicate with the one or more STAs accordingly. In some scenarios, such as in scenarios in which coordinated beamforming is employed, a second AP managing an overlapping BSS (OBSS) also may be expected to use results of measurements performed on channels between the second AP and one or more STAs of the first BSS. In some systems, however, STAs of a BSS may not be expected to be responsive to, or might fail to recognize, NDPA frames and/or NDPs transmitted by an OBSS AP. As such, OBSS APs (such as the second AP managing the OBSS) may be unable to efficiently or accurately obtain channel measurement results from STAs in a BSS managed by an AP with which the STAs are associated (such as STAs in the first BSS managed by the first AP), which may adversely impact or limit many of the benefits that might be achieved with coordinated beamforming.

### SUMMARY

The systems, methods, and devices of this disclosure each have several innovative aspects, no single one of which is solely responsible for the desirable attributes disclosed herein.

One innovative aspect of the subject matter described in this disclosure can be implemented in a first wireless access point (AP). The first wireless AP may include a processing system that includes processor circuitry and memory circuitry that stores code. The processing system may be configured to cause the first wireless AP to transmit a set of sounding packets in accordance with a channel sounding operation at one or more wireless stations (STAs) of a second basic service set (BSS) associated with a second wireless AP different than a first BSS associated with the first wireless AP, the set of sounding packets being associated with one or more parameters indicative of the second BSS, receive, in association with transmitting the set of sounding packets, one or more measurement reports from the one or more wireless STAs of the second BSS, respectively, each measurement report including respective channel state information associated with a respective channel between the respective wireless STA associated with the measurement report and the first wireless AP, and transmit, in accordance with the channel state information, a data packet to at least one wireless STA of the first BSS.

Another innovative aspect of the subject matter described in the disclosure can be implemented in a method for wireless communication performable by a first wireless AP. The method may include transmitting a set of sounding packets in accordance with a channel sounding operation at one or more wireless STAs of a second BSS associated with a second wireless AP different than a first BSS associated with the first wireless AP, the set of sounding packets being associated with one or more parameters indicative of the second BSS, receiving, in association with transmitting the set of sounding packets, one or more measurement reports from the one or more wireless STAs of the second BSS, respectively, each measurement report including respective channel state information associated with a respective channel between the respective wireless STA associated with the measurement report and the first wireless AP, and transmitting, in accordance with the channel state information, a data packet to at least one wireless STA of the first BSS.

Another innovative aspect of the subject matter described in this disclosure can be implemented in a first wireless AP. The first wireless AP may include means for transmitting a set of sounding packets in accordance with a channel sounding operation at one or more wireless STAs of a second BSS associated with a second wireless AP different than a first BSS associated with the first wireless AP, the set of sounding packets being associated with one or more parameters indicative of the second BSS, means for receiving, in association with transmitting the set of sounding packets, one or more measurement reports from the one or more wireless STAs of the second BSS, respectively, each measurement report including respective channel state information associated with a respective channel between the respective wireless STA associated with the measurement report and the first wireless AP, and means for transmitting, in accordance with the channel state information, a data packet to at least one wireless STA of the first BSS.

Another innovative aspect of the subject matter described in this disclosure can be implemented in a non-transitory computer-readable medium storing code for wireless communication at a first wireless AP. The code may include instructions executable by one or more processors, individually or collectively, to cause the first wireless AP to transmit a set of sounding packets in accordance with a channel sounding operation at one or more wireless STAs of a second BSS associated with a second wireless AP different than a first BSS associated with the first wireless AP, the set of sounding packets being associated with one or more parameters indicative of the second BSS, receive, in association with transmitting the set of sounding packets, one or more measurement reports from the one or more wireless STAs of the second BSS, respectively, each measurement report including respective channel state information associated with a respective channel between the respective wireless STA associated with the measurement report and the first wireless AP, and transmit, in accordance with the channel state information, a data packet to at least one wireless STA of the first BSS.

In some examples of the method, first wireless APs, and non-transitory computer-readable medium described herein, each sounding packet of the set of sounding packets includes at least one parameter, of the one or more parameters, indicative of the second BSS.

In some examples of the method, first wireless APs, and non-transitory computer-readable medium described herein, the at least one parameter may be associated with a value of a BSS color subfield, the value of the BSS color subfield being indicative of the second BSS.

Some examples of the method, first wireless APs, and non-transitory computer-readable medium described herein may further include operations, features, means, or instructions for transmitting a sounding announcement frame prior to transmitting the set of sounding packets, the sounding announcement frame including the one or more parameters indicative of the second BSS, where the set of sounding packets may be associated with the one or more parameters in accordance with the sounding announcement frame including the one or more parameters.

In some examples of the method, first wireless APs, and non-transitory computer-readable medium described herein, the one or more parameters include a transmitter address associated with the sounding announcement frame, the transmitter address being indicative of the second wireless AP associated with the second BSS.

Another innovative aspect of the subject matter described in this disclosure can be implemented in a first wireless AP. The first wireless AP may include a processing system that includes processor circuitry and memory circuitry that stores code. The processing system may be configured to cause the first wireless AP to receive one or more measurement reports from one or more wireless STAs, respectively, of a second BSS associated with a second wireless AP different than a first BSS associated with the first wireless AP, each measurement report including respective channel state information associated with a respective channel between the respective wireless STA associated with the measurement report and the first wireless AP and transmit, in accordance with the channel state information, a data packet to at least one wireless STA of the first BSS. The processing system may be further configured to cause the first wireless AP to transmit, using a first transmission power, a first portion of the data packet with or without applying an interference reduction scheme to each respective channel between each of at least a subset of the one or more wireless STAs and the first wireless AP in accordance with the respective channel state information associated with the respective channel and transmit, using a second transmission power, a second portion of the data packet in association with applying the interference reduction scheme to each respective channel between each of at least the subset of the one or more wireless STAs and the first wireless AP in accordance with the respective channel state information associated with the respective channel, the second transmission power being associated with an amount of time synchronization between first transmissions by the first wireless AP and second transmissions by the second wireless AP.

Another innovative aspect of the subject matter described in the disclosure can be implemented in a method for wireless communication performable by a first wireless AP. The method may include receiving one or more measurement reports from one or more wireless STAs, respectively, of a second BSS associated with a second wireless AP different than a first BSS associated with the first wireless AP, each measurement report including respective channel state information associated with a respective channel between the respective wireless STA associated with the measurement report and the first wireless AP and transmitting, in accordance with the channel state information, a data packet to at least one wireless STA of the first BSS. The method may further include transmitting, using a first transmission power, a first portion of the data packet with or without applying an interference reduction scheme to each respective channel between each of at least a subset of the one or more wireless STAs and the first wireless AP in accordance with the respective channel state information associated with the respective channel and transmitting, using a second transmission power, a second portion of the data packet in association with applying the interference reduction scheme to each respective channel between each of at least the subset of the one or more wireless STAs and the first wireless AP in accordance with the respective channel state information associated with the respective channel, the second transmission power being associated with an amount of time synchronization between first transmissions by the first wireless AP and second transmissions by the second wireless AP.

Another innovative aspect of the subject matter described in this disclosure can be implemented in a first wireless AP. The first wireless AP may include means for receiving one or more measurement reports from one or more wireless STAs, respectively, of a second BSS associated with a second wireless AP different than a first BSS associated with the first wireless AP, each measurement report including respective channel state information associated with a respective channel between the respective wireless STA associated with the measurement report and the first wireless AP and means for transmitting, in accordance with the channel state information, a data packet to at least one wireless STA of the first BSS. The first wireless AP may further include means for transmitting, using a first transmission power, a first portion of the data packet with or without applying an interference reduction scheme to each respective channel between each of at least a subset of the one or more wireless STAs and the first wireless AP in accordance with the respective channel state information associated with the respective channel and means for transmitting, using a second transmission power, a second portion of the data packet in association with applying the interference reduction scheme to each respective channel between each of at least the subset of the one or more wireless STAs and the first wireless AP in accordance with the respective channel state information associated with the respective channel, the second transmission power being associated with an amount of time synchronization between first transmissions by the first wireless AP and second transmissions by the second wireless AP.

Another innovative aspect of the subject matter described in this disclosure can be implemented in a non-transitory computer-readable medium storing code for wireless communication at a first wireless AP. The code may include instructions executable by one or more processors, individually or collectively, to cause the first wireless AP to receive one or more measurement reports from one or more wireless STAs, respectively, of a second basic service set (BSS) associated with a second wireless AP different than a first BSS associated with the first wireless AP, each measurement report including respective channel state information associated with a respective channel between the respective wireless STA associated with the measurement report and the first wireless AP and transmit, in accordance with the channel state information, a data packet to at least one wireless STA of the first BSS. The code may include instructions executable by the one or more processors, individually or collectively, to further cause the first wireless AP to transmit, using a first transmission power, a first portion of the data packet with or without applying an interference reduction scheme to each respective channel between each of at least a subset of the one or more wireless STAs and the first wireless AP in accordance with the respective channel state information associated with the respective channel and transmit, using a second transmission power, a second portion of the data packet in association with applying the interference reduction scheme to each respective channel between each of at least the subset of the one or more wireless STAs and the first wireless AP in accordance with the respective channel state information associated with the respective channel, the second transmission power being associated with an amount of time synchronization between first transmissions by the first wireless AP and second transmissions by the second wireless AP.

Some examples of the method, first wireless APs, and non-transitory computer-readable medium described herein may further include operations, features, means, or instructions for receiving an indication of a guard interval duration used by the second wireless AP and transmitting the second portion of the data packet using a relatively lower transmission power or a relatively higher transmission power in accordance with whether the guard interval duration used by the second wireless AP may be greater than or equal to a threshold time duration, where the second transmission power may be one of the relatively lower transmission power and the relatively higher transmission power.

In some examples of the method, first wireless APs, and non-transitory computer-readable medium described herein, the relatively lower transmission power may be used for the second portion of the data packet if the guard interval duration may be less than the threshold time duration and the relatively higher transmission power may be used for the second portion of the data packet if the guard interval duration may be greater than or equal to the threshold time duration.

In some examples of the method, first wireless APs, and non-transitory computer-readable medium described herein, the guard interval duration may be less than the threshold time duration, and the relatively lower transmission power may be a function of one or more received signal strengths at each of the one or more wireless STAs associated with one or more transmissions by the first wireless AP.

In some examples of the method, first wireless APs, and non-transitory computer-readable medium described herein, the second transmission power may be higher than the first transmission power in accordance with the interference reduction scheme being applied to the second portion of the data packet and being absent from the first portion of the data packet.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example wireless communication system that supports interference reduction between wireless communication devices of overlapping basic service sets (OBSSs).

FIG. 3 shows example communication timelines that support interference reduction between wireless communication devices of OBSSs.

FIG. 4 shows an example signaling diagram that supports interference reduction between wireless communication devices of OBSSs.

FIG. 5 shows an example process flow that supports interference reduction between wireless communication devices of OBSSs.

FIG. 6 shows a block diagram of an example wireless communication device that supports interference reduction between wireless communication devices of OBSSs.

FIGS. 7 and 8 show flowcharts illustrating an example processes performable by or at a first wireless AP that support interference reduction between wireless communication devices of OBSSs.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described examples can be implemented in any device, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IOT) network.

Various aspects relate generally to one or more signaling- or configuration-based mechanisms to facilitate interference reduction between two or more wireless communication devices, including as part of a coordinated beamforming scheme employed by access points (APs) managing different basic service sets (BSSs). Some aspects more specifically relate to signaling mechanisms associated with an overlapping BSS (OBSS) channel sounding operation and power control mechanisms associated with OBSS interference mitigation, either or both of which a first AP managing a first BSS may leverage as part of a coordinated beamforming scheme with a second AP managing a second BSS. In accordance with a coordinated beamforming scheme, one or both of the first AP or the second AP may beamform signaling to focus radio frequency (RF) energy toward respective in-BSS stations (STAs) (such as intended receiver devices) and away from respective OBSS STAs.

In implementations in which the first AP leverages OBSS channel sounding, the first AP may associate one or more sounding packets with one or more parameters indicative of the second BSS and may transmit the sounding packet(s) during a channel sounding operation at one or more STAs of (such as associated with or within) the second BSS. In accordance with the sounding packet(s) being associated with the parameter(s) indicative of the second BSS, the STA(s) of the second BSS may interpret the sounding packet(s) as one or more in-BSS sounding packets, which may enable the STA(s) to measure and report channel state information (CSI) using the sounding packet(s) transmitted by the first AP. The first AP may receive the CSI from the STA(s) and, in some implementations, may apply an interference reduction scheme (such as a beamforming scheme) to the links between the first AP and each of the STA(s) of the second BSS in accordance with the received CSI.

Additionally, or alternatively, in implementations in which the first AP leverages power control as part of a coordinated beamforming scheme with the second AP, the first AP may apply portion-by-portion transmission power control to a data packet. For example, as part of a coordinated beamforming scheme, the first AP may select potentially different transmission powers for different portions of a data packet. The first AP may select a first transmission power for a first portion (such as a preamble portion) of the data packet in accordance with whether the first portion is beamformed and may select a second transmission power for a second portion (such as a data portion) of the data packet in accordance with a level of time synchronization between the first AP and the second AP. For example, the first AP may transmit the second portion using a relatively lower transmission power if the first AP and the second AP are relatively unsynchronized and may transmit the second portion using a relatively higher transmission power if first AP and the second AP are relatively synchronized.

Particular aspects of the subject matter described in this disclosure can be implemented to realize one or more of the following potential advantages. For example, by facilitating an acquisition, at the first AP managing the first BSS, of CSI of (such as associated with) a link between the first AP and a STA of the second BSS, the first AP may set a precoder to be approximately orthogonal to a transmission vector associated with the link between the first AP and the STA, which may reduce an amount of interference caused by the first AP at the STA by enabling greater transmission directionality away from the STA. Further, by associating one or more sounding packets with one or more parameters indicative of the second BSS, the first AP may enable earlier generations STAs (such as any STA capable of supporting a channel sounding operation) of the second BSS to measure and report CSI associated with the sounding packets in accordance with the sounding packets appearing as if they had been transmitted by the second AP managing the second BSS. In other words, by associating a sounding packet with the one or more parameters indicative of the second BSS, the first AP may enable OBSS channel sounding in a backwards compatible manner with minimal (if any) additional signaling, which may support less interference at OBSS STAs along with relatively low signaling overhead.

Additionally, in accordance with selecting one or more transmission powers to transmit different portions of a data packet, the first AP may further reduce interference levels at STAs of the second BSS by contributing less RF energy to the system in scenarios in which the STAs of the second BSS may be relatively more susceptible to OBSS interference (such as in scenarios in which a time synchronization between transmissions of the first BSS and the second BSS may be lacking). Moreover, in accordance with reducing interference at OBSS STAs in a backwards compatible manner and maintaining relatively low signaling overhead, aspects of the subject matter described in this disclosure may be further implemented to realize greater reliability, higher data rates, and greater spectral efficiency, among other benefits, by facilitating greater adoption and implementation of coordinated beamforming schemes.

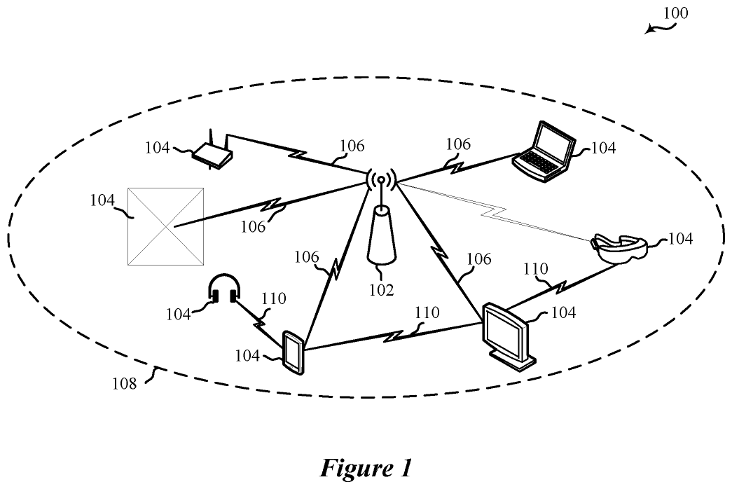

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards (such as defined by the IEEE 802.11-2020 specification or amendments thereof including, but not limited to, 802.11ay, 802.11ax, 802.11az, 802.11ba, 802.11bd, 802.11be, 802.11bf, and 802.11bn). In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core.

The wireless communication network 100 may include numerous wireless communication devices including at least one wireless access point (AP) 102 and any number of wireless stations (STAs) 104. While only one AP 102 is shown in FIG. 1, the wireless communication network 100 can include multiple APs 102. The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of (such as associated with) the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communication (hereinafter also referred to as “Wi-Fi communication” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communication. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

Access to the shared wireless medium is generally governed by a distributed coordination function (DCF). With a DCF, there is generally no centralized master device allocating time and frequency resources of the shared wireless medium. On the contrary, before a wireless communication device, such as an AP 102 or a STA 104, is permitted to transmit data, it may wait for a particular time and then contend for access to the wireless medium. The DCF is implemented through the use of time intervals (including the slot time (or “slot interval”) and the inter-frame space (IFS). IFS provides priority access for control frames used for proper network operation. Transmissions may begin at slot boundaries. Different varieties of IFS exist including the short IFS (SIFS), the distributed IFS (DIFS), the extended IFS (EIFS), and the arbitration IFS (AIFS). The values for the slot time and IFS may be provided by a suitable standard specification, such as one or more of the IEEE 802.11 family of wireless communication protocol standards.

In some examples, the wireless communication device (such as the AP 102 or the STA 104) may implement the DCF through the use of carrier sense multiple access (CSMA) with collision avoidance (CA) (CSMA/CA) techniques. According to such techniques, before transmitting data, the wireless communication device may perform a clear channel assessment (CCA) and may determine (such as identify, detect, ascertain, calculate, or compute) that the relevant wireless channel is idle. The CCA includes both physical (PHY-level) carrier sensing and virtual (MAC-level) carrier sensing. Physical carrier sensing is accomplished via a measurement of the received signal strength of a valid frame, which is then compared to a threshold to determine (such as identify, detect, ascertain, calculate, or compute) whether the channel is busy. For example, if the received signal strength of a detected preamble is above a threshold, the medium is considered busy. Physical carrier sensing also includes energy detection. Energy detection involves measuring the total energy the wireless communication device receives regardless of whether the received signal represents a valid frame. If the total energy detected is above a threshold, the medium is considered busy.

Virtual carrier sensing is accomplished via the use of a network allocation vector (NAV), which effectively serves as a time duration that elapses before the wireless communication device may contend for access even in the absence of a detected symbol or even if the detected energy is below the relevant threshold. The NAV is reset each time a valid frame is received that is not addressed to the wireless communication device. When the NAV reaches 0, the wireless communication device performs the physical carrier sensing. If the channel remains idle for the appropriate IFS, the wireless communication device initiates a backoff timer, which represents a duration of time that the device senses the medium to be idle before it is permitted to transmit. If the channel remains idle until the backoff timer expires, the wireless communication device becomes the holder (or “owner”) of a transmit opportunity (TXOP) and may begin transmitting. The TXOP is the duration of time the wireless communication device can transmit frames over the channel after it has “won” contention for the wireless medium. The TXOP duration may be indicated in the U-SIG field of a PPDU. If, on the other hand, one or more of the carrier sense mechanisms indicate that the channel is busy, a MAC controller within the wireless communication device will not permit transmission.

Each time the wireless communication device generates a new PPDU for transmission in a new TXOP, it randomly selects a new backoff timer duration. The available distribution of the numbers that may be randomly selected for the backoff timer is referred to as the contention window (CW). There are different CW and TXOP durations for each of the four access categories (ACs): voice (AC_VO), video (AC_VI), background (AC_BK), and best effort (AC_BE). This enables particular types of traffic to be prioritized in the network.

In some other examples, the wireless communication device (such as the AP 102 or the STA 104) may contend for access to the wireless medium of wireless communication network 100 in accordance with an enhanced distributed channel access (EDCA) procedure. A random channel access mechanism such as EDCA may afford high-priority traffic a greater likelihood of gaining medium access than low-priority traffic. The wireless communication device using EDCA may classify data into different access categories. Each AC may be associated with a different priority level and may be assigned a different range of random backoffs (RBOs) so that higher priority data is more likely to win a TXOP than lower priority data (such as by assigning lower RBOs to higher priority data and assigning higher RBOs to lower priority data). Although EDCA increases the likelihood that low-latency data traffic will gain access to a shared wireless medium during a given contention period, unpredictable outcomes of medium access contention operations may prevent low-latency applications from achieving certain levels of throughput or satisfying certain latency requirements.

Some APs and STAs (such as the AP 102 and the STAs 104 described with reference to FIG. 1) may implement spatial reuse techniques. For example, APs 102 and STAs 104 configured for communication using the protocols defined in the IEEE 802.11ax or 802.11be standard amendments may be configured with a BSS color. APs 102 associated with different BSSs may be associated with different BSS colors. A BSS color is a numerical identifier of an AP 102's respective BSS (such as a 6 bit field carried by the SIG field). Each STA 104 may learn its own BSS color upon association with the respective AP 102. BSS color information is communicated at both the PHY and MAC sublayers. If an AP 102 or a STA 104 detects, obtains, selects, or identifies, a wireless packet from another wireless communication device while contending for access, the AP 102 or STA 104 may apply different contention parameters in accordance with whether the wireless packet is transmitted by, or transmitted to, another wireless communication device (such another AP 102 or STA 104) within its BSS or from a wireless communication device from an overlapping BSS (OBSS), as determined, identified, ascertained, or calculated by a BSS color indication in a preamble of the wireless packet. For example, if the BSS color associated with the wireless packet is the same as the BSS color of the AP 102 or STA 104, the AP 102 or STA 104 may use a first RSSI detection threshold when performing a CCA on the wireless channel. However, if the BSS color associated with the wireless packet is different than the BSS color of the AP 102 or STA 104, the AP 102 or STA 104 may use a second RSSI detection threshold in lieu of using the first RSSI detection threshold when performing the CCA on the wireless channel, the second RSSI detection threshold being greater than the first RSSI detection threshold. In this way, the criteria for winning contention are relaxed when interfering transmissions are associated with an OBSS.

Some APs and STAs (such as the AP 102 and the STAs 104 described with reference to FIG. 1) may implement techniques for spatial reuse that involve participation in a coordinated communication scheme. According to such techniques, an AP 102 may contend for access to a wireless medium to obtain control of the medium for a TXOP. The AP that wins the contention (hereinafter also referred to as a “sharing AP”) may select one or more other APs (hereinafter also referred to as “shared APs”) to share resources of the TXOP. The sharing and shared APs may be located in proximity to one another such that at least some of their wireless coverage areas at least partially overlap. Some examples may specifically involve coordinated AP TDMA or OFDMA techniques for sharing the time or frequency resources of a TXOP. To share its time or frequency resources, the sharing AP may partition the TXOP into multiple time segments or frequency segments each including respective time or frequency resources representing a portion of the TXOP. The sharing AP may allocate the time or frequency segments to itself or to one or more of the shared APs. For example, each shared AP may utilize a partial TXOP assigned by the sharing AP for its uplink or downlink communication with its associated STAs.

In some examples of such TDMA techniques, each portion of a plurality of portions of the TXOP includes a set of time resources that do not overlap with any time resources of any other portion of the plurality of portions of the TXOP. In such examples, the scheduling information may include an indication of time resources, of multiple time resources of the TXOP, associated with each portion of the TXOP. For example, the scheduling information may include an indication of a time segment of the TXOP such as an indication of one or more slots or sets of symbol periods associated with each portion of the TXOP such as for multi-user TDMA.

In some examples of OFDMA techniques, each portion of the plurality of portions of the TXOP includes a set of frequency resources that do not overlap with any frequency resources of any other portion of the plurality of portions. In such examples, the scheduling information may include an indication of frequency resources, of multiple frequency resources of the TXOP, associated with each portion of the TXOP. For example, the scheduling information may include an indication of a bandwidth portion of the wireless channel such as an indication of one or more subchannels or resource units associated with each portion of the TXOP such as for multi-user OFDMA.

In this manner, the sharing AP's acquisition of the TXOP enables communication between one or more additional shared APs and their respective BSSs, subject to appropriate power control and link adaptation. For example, the sharing AP may limit the transmit powers of the selected shared APs such that interference from the selected APs does not prevent STAs associated with the TXOP owner from successfully decoding packets transmitted by the sharing AP. Such techniques may be used to reduce latency because the other APs may not need to wait to win contention for a TXOP to be able to transmit and receive data according to conventional CSMA/CA or enhanced distributed channel access (EDCA) techniques. Additionally, by enabling a group of APs 102 associated with different BSSs to participate in a coordinated AP transmission session, during which the group of APs may share at least a portion of a single TXOP obtained by any one of the participating APs, such techniques may increase throughput across the BSSs associated with the participating APs and also may achieve improvements in throughput fairness. Furthermore, with appropriate selection of the shared APs and the scheduling of their respective time or frequency resources, medium utilization may be maximized or otherwise increased while packet loss resulting from OBSS interference is minimized or otherwise reduced. Various implementations may achieve these and other advantages without requiring that the sharing AP or the shared APs be aware of the STAs 104 associated with other BSSs, without requiring a preassigned or dedicated master AP or preassigned groups of APs, and without requiring backhaul coordination between the APs participating in the TXOP.

In some examples in which the signal strengths or levels of interference associated with the selected APs are relatively low (such as less than a given value), or when the decoding error rates of the selected APs are relatively low (such as less than a threshold), the start times of the communication among the different BSSs may be synchronous. Conversely, when the signal strengths or levels of interference associated with the selected APs are relatively high (such as greater than the given value), or when the decoding error rates of the selected APs are relatively high (such as greater than the threshold), the start times may be offset from one another by a time period associated with decoding the preamble of a wireless packet and determining, from the decoded preamble, whether the wireless packet is an intra-BSS packet or is an OBSS packet. For example, the time period between the transmission of an intra-BSS packet and the transmission of an OBSS packet may allow a respective AP (or its associated STAs) to decode the preamble of the wireless packet and obtain the BSS color value carried in the wireless packet to determine whether the wireless packet is an intra-BSS packet or an OBSS packet. In this manner, each of the participating APs and their associated STAs may be able to receive and decode intra-BSS packets in the presence of OBSS interference.

In some examples, the sharing AP may perform polling of a set of un-managed or non-co-managed APs that support coordinated reuse to identify candidates for future spatial reuse opportunities. For example, the sharing AP may transmit one or more spatial reuse poll frames as part of determining one or more spatial reuse criteria and selecting one or more other APs to be shared APs. According to the polling, the sharing AP may receive responses from one or more of the polled APs. In some specific examples, the sharing AP may transmit a coordinated AP TXOP indication (CTI) frame to other APs that indicates time and frequency of resources of the TXOP that can be shared. The sharing AP may select one or more candidate APs upon receiving a coordinated AP TXOP request (CTR) frame from a respective candidate AP that indicates a desire by the respective AP to participate in the TXOP. The poll responses or CTR frames may include a power indication, for example, a receive (RX) power or RSSI measured by the respective AP. In some other examples, the sharing AP may directly measure potential interference of a service supported (such as UL transmission) at one or more APs, and select the shared APs based on the measured potential interference. The sharing AP generally selects the APs to participate in coordinated spatial reuse such that it still protects its own transmissions (which may be referred to as primary transmissions) to and from the STAs in its BSS. The selected APs may then be allocated resources during the TXOP as described above.

APs and STAs (such as the AP 102 and the STAs 104 described with reference to FIG. 1) that include multiple antennas may support various diversity schemes. For example, spatial diversity may be used by one or both of a transmitting device (such as either an AP 102 or a STA 104) or a receiving device (such as either an AP 102 or a STA 104) to increase the robustness of a transmission. For example, to implement a transmit diversity scheme, a transmitting device may transmit the same data redundantly over two or more antennas.

APs 102 and STAs 104 that include multiple antennas also may support space-time block coding (STBC). With STBC, a transmitting device also transmits multiple copies of a data stream across multiple antennas to exploit the various received versions of the data to increase the likelihood of decoding the correct data. More specifically, the data stream to be transmitted is encoded in blocks, which are distributed among the spaced antennas and across time. Generally, STBC can be used when the number N_{Tx} of transmit antennas exceeds the number N_{SS} of spatial streams. The N_{SS} spatial streams may be mapped to a number N_{STS} of space-time streams, which are then mapped to N_{Tx} transmit chains.

APs 102 and STAs 104 that include multiple antennas also may support spatial multiplexing, which may be used to increase the spectral efficiency and the resultant throughput of a transmission. To implement spatial multiplexing, the transmitting device divides the data stream into a number N_{SS} of separate, independent spatial streams. The spatial streams are then separately encoded and transmitted in parallel via the multiple N_{Tx} transmit antennas.

APs 102 and STAs 104 that include multiple antennas also may support beamforming. Beamforming generally refers to the steering of the energy of a transmission in the direction of a target receiver. Beamforming may be used both in a single-user (SU) context, for example, to improve a signal-to-noise ratio (SNR), as well as in a multi-user (MU) context, for example, to enable MU-MIMO transmissions (also referred to as spatial division multiple access (SDMA)). In the MU-MIMO context, beamforming may additionally or alternatively involve the nulling out of energy in the directions of other receiving devices. To perform SU beamforming or MU-MIMO, a transmitting device, referred to as the beamformer, transmits a signal from each of multiple antennas. The beamformer configures the amplitudes and phase shifts between the signals transmitted from the different antennas such that the signals add constructively along particular directions towards the intended receiver (referred to as the beamformee) or add destructively in other directions towards other devices to mitigate interference in a MU-MIMO context. The manner in which the beamformer configures the amplitudes and phase shifts depends on channel state information (CSI) associated with the wireless channels over which the beamformer intends to communicate with the beamformee.

To obtain the CSI necessary for beamforming, the beamformer may perform a channel sounding procedure with the beamformee. For example, the beamformer may transmit one or more sounding signals (such as in the form of a null data packet (NDP)) to the beamformee. An NDP is a PPDU without any data field. The beamformee may then perform measurements for each of the N_{Tx}×N_{Rx} sub-channels corresponding to all of the transmit antenna and receive antenna pairs associated with the sounding signal. The beamformee generates a feedback matrix associated with the channel measurements and, typically, compresses the feedback matrix before transmitting the feedback to the beamformer. The beamformer may then generate a precoding (or “steering”) matrix for the beamformee associated with the feedback and use the steering matrix to precode the data streams to configure the amplitudes and phase shifts for subsequent transmissions to the beamformee. The beamformer may use the steering matrix to determine (such as identify, detect, ascertain, calculate, or compute) how to transmit a signal on each of its antennas to perform beamforming. For example, the steering matrix may be indicative of a phase shift and/or a power level to use to transmit a respective signal on each of the beamformer's antennas.

When performing beamforming, the transmitting beamforming array gain is logarithmically proportional to the ratio of N_{Tx} to N_{SS}. As such, it is generally desirable, within other constraints, to increase the number N_{Tx} of transmit antennas when performing beamforming to increase the gain. It is also possible to more accurately direct transmissions or nulls by increasing the number of transmit antennas. This is especially advantageous in MU transmission contexts in which it is particularly important to reduce inter-user interference.

To increase an AP 102's spatial multiplexing capability, an AP 102 may need to support an increased number of spatial streams (such as up to 16 spatial streams). However, supporting additional spatial streams may result in increased CSI feedback overhead. Implicit CSI acquisition techniques may avoid CSI feedback overhead by taking advantage of the assumption that the UL and DL channels have reciprocal impulse responses (that is, that there is channel reciprocity). For example, the CSI feedback overhead may be reduced using an implicit channel sounding procedure such as an implicit beamforming report (BFR) technique (such as where STAs 104 transmit NDP sounding packets in the UL while the AP 102 measures the channel) because no BFRs are sent. Once the AP 102 receives the NDPs, it may implicitly assess the channels for each of the STAs 104 and use the channel assessments to configure steering matrices. In order to mitigate hardware mismatches that could break the channel reciprocity on the UL and DL (such as the baseband-to-RF and RF-to-baseband chains not being reciprocal), the AP 102 may implement a calibration method to compensate for the mismatch between the UL and the DL channels. For example, the AP 102 may select a reference antenna, transmit a pilot signal from each of its antennas, and estimate baseband-to-RF gain for each of the non-reference antennas relative to the reference antenna.

In some examples, multiple APs 102 may simultaneously transmit signaling or communication to a single STA 104 utilizing a distributed MU-MIMO scheme. Examples of such a distributed MU-MIMO transmission include coordinated beamforming (CBF) and joint transmission (JT). With CBF, signals (such as data streams) for a given STA 104 may be transmitted by only a single AP 102. However, the coverage areas of neighboring APs may overlap, and signals transmitted by a given AP 102 may reach the STAs in OBSSs associated with neighboring APs as OBSS signals. CBF allows multiple neighboring APs to transmit simultaneously while minimizing or avoiding interference, which may result in more opportunities for spatial reuse. More specifically, using CBF techniques, an AP 102 may beamform signals to in-BSS STAs 104 while forming nulls in the directions of STAs in OBSSs such that any signals received at an OBSS STA are of sufficiently low power to limit the interference at the STA. To accomplish this, an inter-BSS coordination set may be defined between the neighboring APs, which contains identifiers of all APs and STAs participating in CBF transmissions.

With JT, signals for a given STA 104 may be transmitted by multiple coordinated APs 102. For the multiple APs 102 to concurrently transmit data to a STA 104, the multiple APs 102 may all need a copy of the data to be transmitted to the STA 104. Accordingly, the APs 102 may need to exchange the data among each other for transmission to a STA 104. With JT, the combination of antennas of the multiple APs 102 transmitting to one or more STAs 104 may be considered as one large antenna array (which may be represented as a virtual antenna array) used for beamforming and transmitting signals. In combination with MU-MIMO techniques, the multiple antennas of the multiple APs 102 may be able to transmit data via multiple spatial streams. Accordingly, each STA 104 may receive data via one or more of the multiple spatial streams.

In some implementations, the AP 102 and STAs 104 can support various multi-user communication; that is, concurrent transmissions from one device to each of multiple devices (such as multiple simultaneous downlink communication from an AP 102 to corresponding STAs 104), or concurrent transmissions from multiple devices to a single device (such as multiple simultaneous uplink transmissions from corresponding STAs 104 to an AP 102). As an example, in addition to MU-MIMO, the AP 102 and STAs 104 may support OFDMA. OFDMA is in some aspects a multi-user version of OFDM.

In OFDMA schemes, the available frequency spectrum of the wireless channel may be divided into multiple resource units (RUs) each including multiple frequency subcarriers (also referred to as “tones”). Different RUs may be allocated or assigned by an AP 102 to different STAs 104 at particular times. The sizes and distributions of the RUs may be referred to as an RU allocation. In some examples, RUs may be allocated in 2 MHz intervals, and as such, the smallest RU may include 26 tones consisting of 24 data tones and 2 pilot tones. Consequently, in a 20 MHz channel, up to 9 RUs (such as 2 MHz, 26-tone RUs) may be allocated (because some tones are reserved for other purposes). Similarly, in a 160 MHz channel, up to 74 RUs may be allocated. Other tone RUs also may be allocated, such as 52 tone, 106 tone, 242 tone, 484 tone and 996 tone RUs. Adjacent RUs may be separated by a null subcarrier (such as a DC subcarrier), for example, to reduce interference between adjacent RUs, to reduce receiver DC offset, and to avoid transmit center frequency leakage.

For UL MU transmissions, an AP 102 can transmit a trigger frame to initiate and synchronize an UL OFDMA or UL MU-MIMO transmission from multiple STAs 104 to the AP 102. Such trigger frames may thus enable multiple STAs 104 to send UL traffic to the AP 102 concurrently in time. A trigger frame may address one or more STAs 104 through respective association identifiers (AIDs), and may assign each AID (and thus each STA 104) one or more RUs that can be used to send UL traffic to the AP 102. The AP also may designate one or more random access (RA) RUs that unscheduled STAs 104 may contend for.

Some wireless communication devices (including both APs and STAs such as, for example, AP 102 and STAs 104 described with reference to FIG. 1) are capable of multi-link operation (MLO). In some examples, MLO supports establishing multiple different communication links (such as a first link on the 2.4 GHz band, a second link on the 5 GHz band, and the third link on the 6 GHz band) between the STA 104 and the AP 102 and exchanging packets on one or more communication links concurrently and dynamically. Each communication link may support one or more sets of channels or logical entities. In some examples, each communication link associated with a given wireless communication device may be associated with a respective radio of the wireless communication device, which may include one or more transmit/receive (Tx/Rx) chains, include or be coupled with one or more physical antennas, or include signal processing components, among other components. An MLO-capable device may be referred to as a multi-link device (MLD). An MLD may include a single upper MAC layer, and can include, for example, three independent lower MAC layers and three associated independent PHY layers for respective links in the 2.4 GHz, 5 GHz, and 6 GHz bands. This architecture may enable a single association process and security context. An AP MLD may include multiple APs each configured to communicate on a respective communication link with a respective one of multiple STAs 104 of a non-AP MLD (also referred to as a “STA MLD”). The STA MLD may communicate with the AP MLD over one or more of the multiple communication links at a given time. MLDs may independently contend for access on each of the communication links, which achieves latency reduction by enabling the MLD to transmit its packets on the first communication link that becomes available.

MLO techniques may provide multiple benefits to a wireless communication network 100. For example, MLO may improve user perceived throughput (UPT) (such as by quickly flushing per-user transmit queues). Similarly, MLO may improve throughput by improving utilization of available channels and may increase spectral utilization (such as increasing the bandwidth-time product). Further, MLO may enable smooth transitions between multi-band radios (such as where each radio may be associated with a given RF band) or enable a framework to set up separation of control channels and data channels. Other benefits of MLO include reducing the ON time of a modem, which may benefit a wireless communication device in terms of power consumption. Another benefit of MLO is the increased multiplexing opportunities in the case of a single BSS. For example, multi-link aggregation may increase the number of users per multiplexed transmission served by the multi-link AP MLD.

In some wireless communication systems, multiple APs 102 may support one or multiple different types of coordinated beamforming. For example, two or more APs 102 may support one or both of symmetric coordinated beamforming (sCoBF) or asymmetric coordinated beamforming (aCoBF). Across both types of coordinated beamforming, an AP 102 may attempt to direct a transmission toward a first STA 104 and away from, for example, a second STA 104. In some scenarios, an AP 102 may be able to direct a transmission toward the first STA 104 and away from the second STA 104 in accordance with CSI associated with a channel (such as a link) between the AP 102 and the second STA 104. For example, in accordance with the CSI associated with the channel between the AP 102 and the second STA 104, the AP 102 may be able to set a precoder of the AP 102 to be (approximately or nearly) orthogonal to a transmission vector associated with the CSI of the channel. In other words, the AP 102 may select and apply various beamforming and/or precoding weights to reduce side lobes or otherwise reduce an amount of RF energy that propagates in the direction of the second STA 104.

In some scenarios, however, the AP 102 may lack an efficient mechanism for obtaining the CSI associated with the channel between the AP 102 and the second STA 104. Such scenarios may include, for example, scenarios in which the AP 102 is a first AP 102 of a first BSS and the second STA 104 is of a second BSS, the first BSS being an OBSS relative to the second BSS. In such scenarios, the first AP 102 of the first BSS may experience one or more implementation challenges relating to obtaining channel feedback from the second STA 104 of the second BSS (and any other OBSS STAs 104), mitigating interference caused by some portions (such as some preamble portions) of nulled packets, and/or accounting for various generations of STAs 104 (including, for example, legacy STAs 104 or STAs 104 that otherwise have varying levels of capabilities). For example, while an AP 102 of a BSS may be able to initiate a channel sounding operation with STAs 104 of a same BSS, some APs 102 may lack an efficient mechanism according to which CSI associated with OBSS STAs 104 can be obtained, as STAs 104 (or at least a relatively large subset of STAs 104) may refrain from measuring and reporting CSI using sounding packets associated with a BSS different than their own.

In some implementations, a first AP 102 of a first BSS may employ one or more signaling- or configuration-based mechanisms associated with obtaining downlink channel estimates to OBSS STAs 104 (such as one or more STAs 104 of a second BSS), preamble interference mitigation, and/or reduced transmission power levels for coordinated beamforming transmissions in select scenarios (to mitigate, minimize, or otherwise reduce an impact, such as an interference contribution, to devices of a TXOP winning BSS). In some aspects, the first AP 102 may obtain channel estimates to OBSS STAs 104 (including all or various generations of OBSS STAs 104, including legacy (such as Wi-Fi generation 7 or earlier) OBSS STAs 104) in accordance with null data packet announcement (NDPA) and/or null data packet (NDP) “spoofing” for OBSS downlink channel estimation. Such NDPA and/or NDP “spoofing” may refer to how the first AP 102 of the first BSS transmits an NDPA and/or a set of NDPs such that the NDPA and/or the set of NDPs appear (such as to STAs 104 of the second BSS) as if the NDPA and/or the set of NDPs had been transmitted by a second AP 102 of the second BSS. Additionally, or alternatively, the first AP 102 may achieve preamble interference mitigation and/or employ reduced transmission power levels for coordinated beamforming transmissions in accordance with one or more link nulling- or power control-based techniques. Such link nulling- or power control-based techniques may include selective link nulling of a preamble portion and/or a data portion of a data packet, a transmission power selection protocol associated with whether link nulling is present on a portion-by-portion basis across a data message, and/or a transmission power selection protocol associated with an amount or level of time synchronization between transmissions in the first BSS and transmissions in the second BSS.

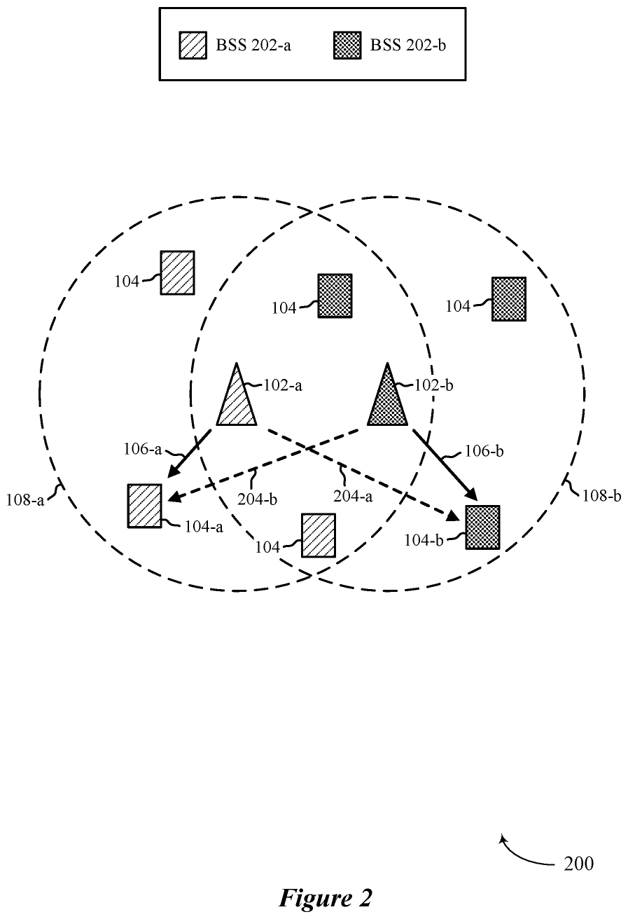

FIG. 2 shows an example wireless communication system 200 that supports interference reduction between wireless communication devices of OBSSs. The wireless communication system 200 may implement or be implemented to realize aspects of the wireless communication network 100. For example, the wireless communication system 200 may include an AP 102-a and an AP 102-b, each of which may be an example of an AP 102 as illustrated by and described with reference to FIG. 1. Further, the wireless communication system 200 may include various STAs 104, including a STA 104-a and a STA 104-b, each of such various STAs 104 being an example of a STA 104 as illustrated by and described with reference to FIG. 1. The AP 102-a may transmit to the STA 104-a via a communication link 106-a and the AP 102-b may transmit to the STA 104-b via a communication link 106-b.

The AP 102-a may serve devices within a geographic area 108-a associated with a BSS 202-a and the AP 102-b may serve devices within a geographic area 108-b associated with a BSS 202-b. In some aspects, the BSS 202-a may be an OBSS relative to the BSS 202-b. In other words, from the perspective of the BSS 202-a, the BSS 202-b may be an OBSS and, from the perspective of the BSS 202-b, the BSS 202-a may be an OBSS. As such, from the perspective of devices of the BSS 202-a, the AP 102-a and the STA 104-a may be understood as a BSS AP and a BSS STA, respectively, and the AP 102-b and the STA 104-b may be understood as an OBSS AP and an OBSS STA, respectively. Likewise, from the perspective of devices of the BSS 202-b, the AP 102-a and the STA 104-a may be understood as an OBSS AP and an OBSS STA, respectively, and the AP 102-b and the STA 104-b may be understood as a BSS AP and a BSS STA, respectively. In some aspects, which of the BSS 202-a or the BSS 202-b is designated as the OBSS may be associated with which of the AP 102-a or the AP 102-b is a TXOP winner. For example, if the AP 102-a wins a TXOP, the BSS 202-a may be understood as the BSS and the BSS 202-b may be understood as the OBSS. Alternatively, if the AP 102-b wins a TXOP, the BSS 202-a may be understood as the OBSS and the BSS 202-b may be understood as the BSS.

The AP 102-a and/or the AP 102-b may support one or more of various types of coordinated beamforming (such as one or more of various beamforming-based AP coordination techniques). For example, the AP 102-a and/or the AP 102-b may support one or both of sCoBF and aCoBF. In some aspects, the AP 102-a and/or the AP 102-b may employ sCoBF or aCoBF to manage interference levels in scenarios in which both the AP 102-a and the AP 102-b are actively (such as simultaneously) transmitting to respective in-BSS STAs. For example, the AP 102-a and/or the AP 102-b may employ sCoBF or aCoBF to manage interference levels in scenarios in which the AP 102-a transmits to the STA 104-a via a communication link 106-a and the AP 102-b transmits to the STA 104-b via a communication link 106-b simultaneously or during at least partially overlapping time periods. By employing coordinated beamforming techniques to enable simultaneous or at least partially overlapping transmissions by two different APs 102 in different BSSs, the different BSSs may, in aggregate, experience significant throughput gain in some scenarios.

In accordance with sCoBF, APs 102 of both a BSS and an OBSS may employ beamforming (such as a setting or configuring of precoding weights to enable or facilitate directional transmission) to create nulls (such as areas or directions of relatively low interference) toward STAs of the other AP 102 irrespective of which AP 102 is a TXOP winner. For example, regardless of which of the AP 102-a or the AP 102-b obtains (such as wins) a TXOP, the AP 102-a may employ beamforming to create a null toward the STA 104-b (to reduce, minimize, or mitigate interference 204-a toward the STA 104-b) as part of transmitting to the STA 104-a and the AP 102-b may employ beamforming to create a null toward the STA 104-a (to reduce, minimize, or mitigate interference 204-b toward the STA 104-a) as part of transmitting to the STA 104-b. In accordance with such sCoBF techniques, over-the-air (OTA) interference at both the STA 104-a and the STA 104-b may be reduced (such as minimized, mitigated, or avoided) at the cost of both the AP 102-a and the AP 102-b incurring some amount of precoding loss (as both the AP 102-a and the AP 102-b set precoding weights in accordance with both directivity gain and interference mitigation, instead of directivity gain alone). Further, in accordance with sCoBF, both the AP 102-a and the AP 102-b may be expected to gather CSI associated with OBSS STAs 104 and (roughly or approximately) time-synchronize their respective transmissions.

In accordance with aCoBF, an AP 102 of a TXOP losing BSS may employ beamforming (such as a setting or configuring of precoding weights to enable or facilitate directional transmission) to create nulls (such as areas or directions of relatively low interference) toward STAs 104 of a TXOP winning BSS. For example, if the AP 102-a is a TXOP winner and the AP 102-b is a TXOP loser, the AP 102-b may employ beamforming to create a null towards the STA 104-a (to reduce, minimize, or mitigate interference 204-b toward the STA 104-a) of the BSS 202-a (the TXOP winning BSS) and the AP 102-a may refrain from creating a null towards the STA 104-b of the BSS 202-b (the TXOP losing BSS). In accordance with such aCoBF techniques, a TXOP winning AP 102 (such as the AP 102-a) may avoid throughput loss (as directivity gain alone may be prioritized by the TXOP winning AP 102) and a TXOP losing AP 102 may implicitly obtain an extra TXOP (as the TXOP losing AP 102 may still transmit during the TXOP) at a cost of some amount of precoding and interference loss. Further, in accordance with aCoBF, the TXOP losing AP 102 may be expected to gather sufficient information (such as sufficient channel information and/or metrics, such as CSI) to enable the TXOP losing AP 102 to avoid or reduce interference toward a STA 104 of a TXOP winning BSS (such as to avoid adversely impacting the TXOP holder, which may be understood as the TXOP winner).

In some scenarios, obtaining CSI associated with a channel between an OBSS STA 104 and a BSS AP 102, such as via a channel sounding operation, may be associated with various deployment challenges. For example, some STAs 104 may recognize and be expected to respond to sounding frames or packets that are transmitted by an AP 102 with which the STAs 104 are associated, but may not be expected to respond to (and/or may be incapable of recognizing) sounding frames or packets that are transmitted by an AP 102 with which the STAs 104 are not associated. Such sounding frames or packets may include an NDPA frame and/or an NDP and a STA 104 may recognize, identify, ascertain, or otherwise determine an origin of an NDPA frame and/or an NDP in accordance with one or more field values and/or a reception timing relative to another frame.

For example, a STA 104 may recognize an NDPA frame of an associated AP 102 from a transmitter address (TA) field of the NDPA frame. For further example, a STA 104 may recognize a high efficiency (HE) or extremely high throughput (EHT) NDP of an associated AP 102 from a BSS color subfield of one or more signal (SIG) fields of the NDP (such as a BSS Color subfield of an HE-SIG-A field or a universal SIG (U-SIG) field of the NDP). For further example, a STA 104 may recognize a very high throughput (VHT) NDP from a preceding NDPA frame (such as in accordance with the VHT NDP being immediately subsequent to a preceding NDPA frame that identifies an associated AP 102), as a VHT NDP may lack an explicit field that might be associated with (such as used for) AP recognition.

In accordance with sCoBF and aCoBF, however, an AP 102 may be expected to use CSI associated with one or more unassociated STAs 104 (potentially in addition to CSI associated with one or more associated STAs 104). For example, for sCoBF, both the AP 102-a and the AP 102-b may be expected to determine and use channel estimates of a channel between the AP 102-a and the STA 104-b and channel estimates of a channel between the AP 102-b and the STA 104-a, respectively, to employ beamforming and null (or otherwise reduce, minimize, or mitigate interference levels) channels toward OBSS STAs 104. For aCoBF, at least the AP 102-b (such as the TXOP losing AP 102) may be expected to determine and use channel estimates of a channel between the AP 102-b and the STA 104-a to employ beamforming and null (or otherwise reduce, minimize, or mitigate interference levels) channels toward OBSS STAs 104.

To address the challenges associated with obtaining CSI associated with a channel between an OBSS STA 104 and a BSS AP 102 (to enable sCoBF and aCoBF), some systems may mandate (in accordance with, for example, a minimum expected capability) STAs 104 to recognize and respond to OBSS NDPA frames and OBSS NDPs, in addition to BSS NDPA frames and BSS NDPs. As described herein, an “OBSS frame or packet” may be understood as indicating or implying that the frame or packet is transmitted by a device in an OBSS and, similarly, a “BSS frame or packet” may be understood as indicating or implying that the frame or packet is transmitted by a device in a same BSS. Such an approach associated with mandating a minimum expected capability, however, may limit the benefits of sCoBF and aCoBF to scenarios in which all (or at least most) STAs 104 are capable of recognizing and responding to OBSS NDPA frames and OBSS NDPs, which may be relatively uncommon in some deployments. For example, even if relatively newer generation STAs 104 have a capability to recognize and respond to OBSS NDPA frames and OBSS NDPs, a relatively large percentage of STAs 104 in a system may lack such a capability, and thus may be excluded from sCoBF and aCoBF interference reduction schemes (as transmitting devices may be unable to efficiently reduce interference toward such STAs 104).

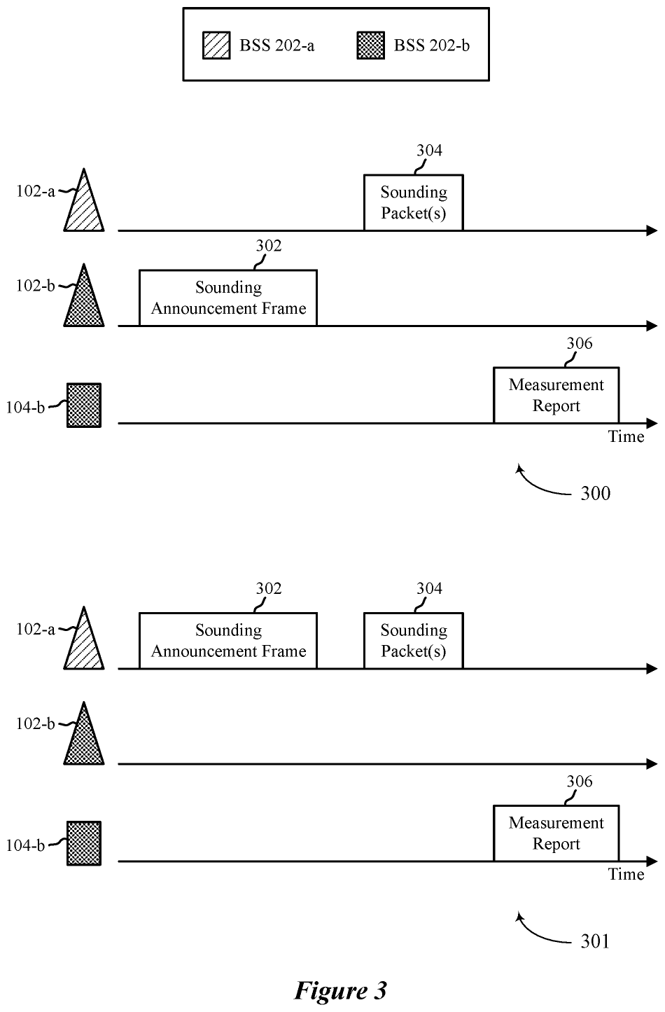

In some implementations, the AP 102-a and/or the AP 102-b may employ NDPA frame and/or NDP spoofing to obtain OBSS downlink channel estimation via a channel sounding operation (such as via explicit sounding). As described herein, an AP 102 may “spoof” a frame or packet to cause the frame or packet to appear as if the frame or packet was transmitted by another device. For example, “spoofing” a frame or packet may include generating, configuring, or setting one or more fields or parameters of the frame or packet or timing a transmission of the frame or packet such that a receiving device decoding the frame or packet interprets (such as expects or assumes) that the frame or packet was transmitted by another device. Accordingly, in some implementations, the AP 102-a and/or the AP 102-b may spoof an NDPA/NDP exchange (which may be an unprotected signaling exchange in some systems) to appear as if the exchange were originating from a neighboring AP 102 (such as the other of the AP 102-a and the AP 102-b). The AP 102-a and/or the AP 102-b may employ one or more variants of such an NDPA/NDP exchange spoofing, including a “full spoofing” variant and a “cooperative spoofing” variant. In some aspects, the AP 102-a and/or the AP 102-b may employ one of such variants in accordance with (such as depending on) a level of cooperation between the AP 102-a and the AP 102-b (such as between BSS and OBSS APs 102). Additional details relating to such a spoofing of an NDPA/NDP exchange are illustrated by and described herein, including with reference to FIG. 3.

In accordance with spoofing an NDPA/NDP exchange, a BSS AP 102 may obtain CSI for each of one or more respective channels between each of one or more OBSS STAs 104 and the BSS AP 102. The BSS AP 102 may obtain the CSI for each of the one or more respective channels via one or more measurement reports, which the BSS AP 102 may receive directly from the one or more OBSS STAs 104 (by overhearing transmissions by the one or more OBSS STAs 104 to an OBSS AP 102) or indirectly from an OBSS AP 102 (via a backhaul communication link between the BSS AP 102 and the OBSS AP 102). The BSS AP 102 may use the CSI for each of the one or more respective channels to apply an interference reduction scheme to each of the one or more respective channels, which may reduce, minimize, mitigate, or avoid causing interference at the one or more OBSS STAs 104. In other words, the BSS AP 102 may apply the interference reduction scheme as part of beamforming transmissions in a manner to null links between the BSS AP 102 and the one or more OBSS STAs 104 (such as the one or more OBSS STAs 104 that may be simultaneously receiving data from an OBSS AP 102).

FIG. 3 shows example communication timelines 300 and 301 that support interference reduction between wireless communication devices of OBSSs. The communication timelines 300 and 301 may implement or be implemented to realize aspects of the wireless communication network 100 or the wireless communication system 200. For example, the communication timelines 300 and 301 illustrate signaling exchanges involving an AP 102-a, an AP 102-b, and a STA 104-b, which may be examples of the AP 102-a, the AP 102-b, and the STA 104-b, respectively, as illustrated by and described with reference to FIG. 2. In some implementations, the AP 102-a may employ NDPA frame and/or NDP spoofing to obtain OBSS downlink channel estimation via a channel sounding operation at the STA 104-b. For example, in the example of the communication timelines 300 and 301, the AP 102-a (an OBSS AP 102) may gather CSI associated with a channel between the AP 102-a and the STA 104-b (a BSS STA 104) and may use the CSI to apply an interference reduction scheme to reduce, minimize, mitigate, or avoid causing interference at the STA 104-b.

The communication timeline 300 may be an example of a “cooperative spoofing” variant and the communication timeline 301 may be an example of a “full spoofing” variant of a spoofed NDPA/NDP exchange. In some aspects, the “cooperative spoofing” variant of a spoofed NDPA/NDP exchange may be employed by cooperating or “friendly” APs 102 (such as APs 102 in an enterprise or mesh deployment) and the “full spoofing” variant of a spoofed NDPA/NDP exchange may be employed by non-cooperating or “unfriendly” APs 102 (such as APs 102 in a retail deployment).

In accordance with the communication timeline 300, the AP 102-b may transmit a sounding announcement frame 302 (such as an NDPA frame) to initiate a channel sounding procedure at the STA 104-b and the AP 102-a may transmit a set of sounding packets 304 (such as a set of one or more NDPs, including a set of a single NDP such that there is one NDP per NDPA frame). In other words, the sounding announcement frame 302 may be sent from the BSS and the NDP(s) may be sent from the OBSS. The set of sounding packets 304 may include a set of one or more sounding packets. In some implementations, the AP 102-a may transmit the set of sounding packets 304 in accordance with generating, configuring, or scheduling the set of sounding packets 304 to appear as if the set of sounding packets 304 were transmitted by the AP 102-b. In some aspects, generating, configuring, or scheduling the set of sounding packets 304 to appear as if the set of sounding packets 304 were transmitted by the AP 102-b may be understood as associating the set of sounding packets 304 with one or more parameters that are indicative of the BSS 202-b (such as the BSS of the AP 102-b).

In some examples, the AP 102-a may associate the set of sounding packets 304 with the one or more parameters that are indicative of the BSS 202-b in accordance with setting a parameter of each of the set of sounding packets 304 to be indicative of the BSS 202-b. Such a parameter may be a value of a BSS color subfield in each of the set of sounding packets 304. In such examples, instead of including a value indicative of a BSS color of the BSS 202-a associated with the AP 102-a in the BSS color subfield in each of the set of sounding packets 304, the AP 102-a may include a value indicative of a BSS color of the BSS 202-b. As such, the STA 104-b may receive the set of sounding packets 304 and recognize the BSS color as being indicative of the BSS 202-b to which the STA 104-b belongs. The AP 102-a may include a value of a BSS color subfield in each of the set of sounding packets 304 indicative of the BSS 202-b in examples in which the set of sounding packets 304 are a first type of sounding packets, such as HE or EHT sounding packets.

Additionally, or alternatively, the AP 102-a may associate the set of sounding packets 304 with the one or more parameters that are indicative of the BSS 202-b in accordance with transmitting the set of sounding packets 304 immediately subsequent to the sounding announcement frame 302. For example, the sounding announcement frame 302 may include the one or more parameters indicative of the BSS 202-b and, by transmitting the set of sounding packets 304 immediately subsequent to the sounding announcement frame 302, the AP 102-a may effectively associate the set of sounding packets 304 with the one or more parameters. In such examples, the one or more parameters may refer to a TA of the sounding announcement frame 302 and/or one or more other identifiers that relate to the BSS 202-b (such as one or more AID values indicative of one or more STAs 104 of the BSS 202-b). In some aspects, the sounding announcement frame 302 and the set of sounding packets 304 being immediately subsequent may be understood as the set of sounding packets 304 being transmitted within or at a short interframe space (SIFS) duration relative to an end of the sounding announcement frame 302.

In accordance with associating the set of sounding packets 304 with the one or more parameters that are indicative of the BSS 202-b, the STA 104-b may recognize, measure, and report CSI associated with the set of sounding packets 304. In some aspects, the STA 104-b may transmit the CSI via a measurement report 306, such as a coordinated beamforming (CBF) report. The AP 102-a may receive the measurement report 306 directly from the STA 104-b or indirectly via the AP 102-b. In some implementations, for example, the AP 102-a may receive the measurement report 306 in accordance with monitoring a channel between the AP 102-b and the STA 104-b (such that the measurement report 306 may be overheard by the OBSS). Additionally, or alternatively, the AP 102-a may receive the measurement report 306 (or contents or information of the measurement report 306) via a backhaul communication link between the AP 102-a and the AP 102-b (such that the measurement report 306, or contents or information thereof, may be shared by the BSS via the backhaul).

In accordance with the communication timeline 301, the AP 102-a may transmit the sounding announcement frame 302 (such as the NDPA frame) and the set of sounding packets 304 (such as the set of one or more NDPs, including a set of a single NDP such that there is one NDP per NDPA frame). In some implementations, the AP 102-a may spoof both the sounding announcement frame 302 and the set of sounding packets 304 to appear as if the sounding announcement frame 302 and the set of sounding packets 304 were transmitted by the AP 102-b. In other words, in accordance with the “full spoofing” illustrated by the communication timeline 301, a spoofed NDPA and the NDP(s) may be sent by the OBSS. The AP 102-a may spoof the set of sounding packets 304 as described with reference to the communication timeline 300 and may additionally spoof the sounding announcement frame 302 in accordance with generating or configuring the sounding announcement frame 302 to include one or more parameters indicative of the BSS 202-b (the BSS to which the STA 104-b belongs).

In some examples, such one or more parameters may include a TA of the sounding announcement frame 302 and/or one or more identifiers that relate to the BSS 202-b (such as one or more AID values indicative of one or more STAs 104 of the BSS 202-b). For example, the AP 102-a may learn a TA associated with the AP 102-b (such as via a signaled indication from the AP 102-b or by overhearing signaling to or from the AP 102-b) and may include the TA associated with the AP 102-b in the sounding announcement frame 302 that the AP 102-a transmits. Additionally, in some examples, the AP 102-a may address the sounding announcement frame 302 to one or more STAs 104 (including the STA 104-b) by including one or more AIDs in the sounding announcement frame 302 (including an AID corresponding to the STA 104-b), as NDP sounding (and trigger based (TB) sounding especially) is associated with a use of AID for addressing.

The STA 104-b may recognize and be responsive to the sounding announcement frame 302 in accordance with the sounding announcement frame 302 including a TA associated with the AP 102-b and/or an AID of the STA 104-b. The STA 104-b may further recognize, measure, and report CSI associated with the set of sounding packets 304 transmitted by the AP 102-a. In some examples, the STA 104-b may transmit the CSI via the measurement report 306. The STA 104-b may transmit the measurement report 306 to the AP 102-b (such that an RA of (such as associated with or included within) the measurement report 306 is indicative of the AP 102-b) and, in some implementations, the AP 102-a may receive the measurement report 306 by monitoring the channel between the STA 104-b and the AP 102-b (such that the measurement report 306 may be overheard by the OBSS).

In examples in which the AP 102-a spoofs BSS STA parameters in the sounding announcement frame 302 (including the one or more AIDs), the AP 102-a may learn or otherwise obtain information indicative of the AIDs to be able to transmit the sounding announcement frame 302. Further, to be able to perform link nulling, the AP 102-a may identify or otherwise determine a mapping of AID to MAC address of (such as associated with) BSS STAs 104 (including, for example, the STA 104-b). In some implementations, the AP 102-a may employ one or more techniques to learn active BSS STA IDs (including AIDs and MAC addresses) to enable the AP 102-a to employ the “full spoofing” variant of a spoofed NDPA/NDP exchange. Such techniques may include techniques associated with non-TB sounding and techniques associated with TB sounding. In addition to, or as an alternative to, such techniques, the AP 102-a may receive BSS AID information from the AP 102-b via a backhaul communication link between the AP 102-a and the AP 102-b (in scenarios in which the AP 102-a and the AP 102-b support, at least in part, cooperative spoofing).

In accordance with techniques associated with non-TB sounding, the AP 102-a (such as the OBSS AP 102) may overhear one or more BSS sounding announcement frames to obtain information indicative of one or more AIDs and corresponding MAC addresses of BSS STAs. The AP 102-a also may overhear subsequent measurement reports to obtain information indicative of MAC addresses and AIDs. For example, the AP 102-a may monitor communication to and/or from the AP 102-b over time to receive (such as overhear) one or more sounding announcement frames and one or more corresponding measurement reports and may aggregate information obtained from such sounding announcement frames and measurement reports to determine a mapping of AID to MAC address for BSS STAs 104. In some implementations, the AP 102-a may obtain information indicative of both AIDs and MAC addresses of BSS STAs via a sounding announcement frame (such as an NDPA frame) and may overhear subsequent measurement reports to confirm a mapping between AIDs and MAC addresses. The AP 102-a may use the overheard AIDs to perform spoofing-based sounding (such as OBSS channel sounding), such as the “full spoofing” variant illustrated by the communication timeline 301.

In accordance with techniques associated with TB sounding, the AP 102-a (such as the OBSS AP 102) may overhear BSS sounding announcement frames to obtain information indicative of one or more AIDs of BSS STAs, but may not be able to overhear corresponding measurement reports (as such measurement reports, which may be examples of uplink multi-user (ULMU) CBF reports, may be triggered by the AP 102-b using MAC addresses as yet unknown by the AP 102-a). As such, the AP 102-a may perform TB sounding using one or more overheard BSS STA AIDs and may obtain information indicative of one or more BSS STA MAC addresses via one or more measurement reports 306 transmitted in response to the TB sounding. In some implementations, the AP 102-a may perform or participate in an initial TB sounding operation to obtain BSS STA AIDs and BSS STA MAC addresses with some amount of cooperation with the AP 102-b. For example, the AP 102-a may coordinate with the AP 102-b to determine when the AP 102-b is expected to transmit a trigger frame (or may otherwise determine when the AP 102-b transmits the trigger frame, with or without cooperation). Such a trigger frame may be a beamforming report poll (BFRP) frame. The AP 102-a may monitor for measurement reports 306 transmitted in response to the trigger frame in accordance with the expected timing of the trigger frame and may obtain information indicative of the BSS STA MAC addresses by receiving and parsing the measurement reports 306.

Further, although illustrated in the context of non-TB sounding in the examples of the communication timelines 300 and 301, the AP 102-a and/or the AP 102-b may employ TB sounding to solicit the measurement report 306 from the STA 104-b. In the example of the communication timeline 300 (which may be illustrative of the “coordinated spoofing” variant), the sounding packets 304 may be understood as being “spoofed” and the sounding announcement frame 302 and a triggering frame, such as a BFRP frame, may not be spoofed (and instead may be transmitted by the AP 102-b). Alternatively, in the example of the communication timeline 301 (which may be illustrative of the “full spoofing” variant), the sounding announcement frame 302, the set of sounding packets 304, and a triggering frame, such as a BFRP frame, may be understood as being “spoofed.” In other words, for TB sounding (such as EHT TB sounding), a BFRP frame may be sent in a similar manner as the sounding announcement frame 302 in each respective spoofing scheme (such as sent via the OBSS in the “full spoofing” scheme and via the BSS in the “cooperative spoofing” scheme). In some aspects, each of the sounding announcement frame 302, the set of sounding packets 304, and the measurement report 306 (and a triggering frame, such as a BFRP frame, if present) may be separated in the time domain by a SIFS duration.

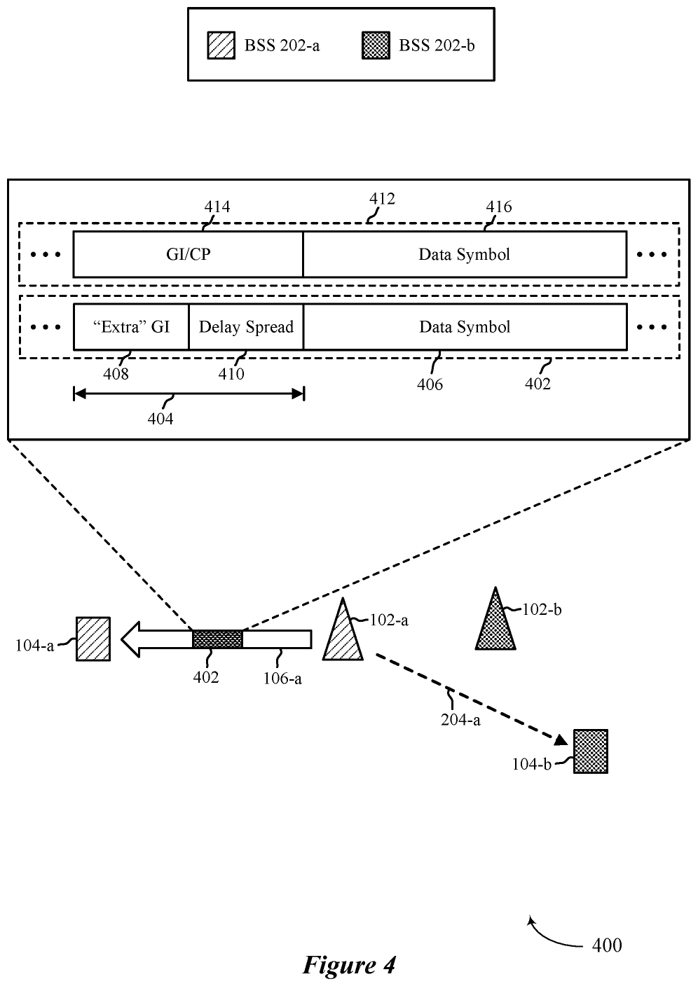

FIG. 4 shows an example signaling diagram 400 that supports interference reduction between wireless communication devices of OBSSs. The signaling diagram may implement or be implemented to realize aspects of the wireless communication network 100, the wireless communication system 200, or one or both of the communication timelines 300 and 301. For example, the signaling diagram 400 illustrates communication between an AP 102-a, an AP 102-b, a STA 104-a, and a STA 104-b, which may be examples of the AP 102-a, the AP 102-b, the STA 104-a, and the STA 104-b as illustrated by and described with reference to FIG. 2. In some implementations, the AP 102-a may apply an interference reduction scheme (such as beamforming) as part of transmitting a data packet 402 (which may be an example of a PPDU) via a communication link 106-a to reduce, minimize, mitigate, or avoid causing interference 204-a toward the STA 104-b. Additionally, in some implementations, the AP 102-a may employ one or more power control mechanisms to further reduce the interference 204-a toward the STA 104-b. In accordance with the illustration in the example of FIG. 4, the data packet 402 may be shown as including one OFDM symbol of a data portion of the data packet 402, the data packet 402 may include any number of OFDM symbols of the data portion. Additionally, the data packet 402 may include any number of OFDM symbols of a preamble portion of the data packet 402.

For example, in some scenarios of link nulling and coordinated beamforming, despite nulling (such as reducing, minimizing, mitigating, cancelling, or avoiding) in the frequency domain, there may still be some amount of residual interference 204-a from some portions of the data packet 402. Such portions of the data packet 402 may include a preamble portion (such as a first portion) of the data packet 402 and any non-nulled guard interval (GI) portions 404 of an (otherwise nulled) data portion (such as a second portion) of the data packet 402. For example, even if a data packet 402 (such as a signal conveying information associated with the data packet 402) is “nulled” (such as transmitted in accordance with an application of an interference reduction scheme, such as beamforming) toward the STA 104-b, a preamble portion (such as a legacy preamble portion) may still be associated with a relatively large signal amplitude (such as a signal amplitude that is approximately of a same amplitude as a transmission intended for the OBSS STA 104, such as a TXOP winning AP transmission).

The preamble portion may be associated with a relatively large signal amplitude in accordance with the preamble portion being a non-beamformed (such as non-nulled) portion of the data packet 402. Further, in addition to the preamble portion, various spikes in signal amplitude may be present throughout the data portion of the data packet 402 (which may be comparatively small relative to the signal amplitude of the preamble portion but nonetheless still contribute to the interference 204-a). Such various spikes, which may be referred to as OBSS spikes, in signal amplitude may correspond to non-beamformed (such as non-nulled) GI portions 404 of the otherwise beamformed data portion. For example, the data packet 402 may include a quantity of OFDM symbols, each OFDM symbol including a GI portion 404 and a data symbol portion 406 within a larger data portion. A duration of such spikes may be approximately of the order of a delay spread of a channel. In other words, a spike duration may be approximately equal to the delay spread of the channel. An impact of non-nulled GI spikes may be associated with an interferer's RSSI to a BSS STA 104.

In some aspects, for both sCoBF and aCoBF, an AP 102 may select to perform nulling (or otherwise attempt to reduce interference via beamforming or other directional transmission configurations) in a non-legacy portion (such as the data portion) of the data packet 402 and may refrain from beamforming a legacy portion (such as the preamble portion) of the data packet 402. In some other aspects, an AP 102 may employ a technique to mitigate (such as minimize, reduce, or avoid) interference in a BSS transmission's legacy portion. In some implementations, for example, an AP 102 may perform legacy nulling (such as a nulling of a legacy preamble portion) according to which the AP 102 may apply precoding to the preamble portion of the data packet 402. In such implementations, the AP 102 may employ (such as use) a different tone mapping for the preamble portion. Additionally, or alternatively, an AP 102 may, at least for aCoBF, power down the preamble portion of the data packet 402 to a level at which OBSS-PD spatial reuse (SR) operation may have otherwise applied in a given scenario. For example, by powering down the preamble portion of the data packet 402 to a level at which OBSS-PD SR operation may have otherwise applied or operated, a level of the interference 204-a measured from the preamble portion may be less than or equal to what OBSS-PD based SR would have otherwise resulted or operated in. Further, powering down the preamble portion may be associated with less implementation complexity as compared to nulling (such as beamforming or otherwise applying precoding to) the preamble portion.

Additionally, or alternatively, time synchronization between transmissions by the AP 102-a of the BSS 202-a and transmissions by the AP 102-b of the BSS 202-b may reduce an amount of the interference 204-a that adversely impacts data reception at the STA 104-b, which may attempt to receive a data packet 412 that includes OFDM symbols each including a GI/cyclic prefix (CP) 414 and a data symbol portion 416. For example, if OBSS spikes fall within an “extra” GI 408 of BSS symbols, the OBSS spikes may not affect a BSS OFDM symbol constructed after Fast Fourier Transform (FFT) of the data symbol portion 416 (a time domain data symbol). Further, OBSS spikes may be formed at a start of a GI at which point a circular convolution property may not be met. As such, in view of an amount of delay spread 410 associated with a channel, an OBSS PPDU (such as the data packet 402) may lag a BSS PPDU (such as the data packet 412 by the “extra” GI 408 worth of duration without affecting BSS performance. Accordingly, in some implementations, the AP 102-a may configure a duration of the GI portion 404 to be at least as long as a sum of the “extra” GI 408 and the delay spread 410, the “extra” GI 408 referring to a time synchronization (safety) margin to place OBSS spikes within the GI/CP 414 of the data packet 412 (or vice versa, such as to place OBSS spikes caused by the GI/CP 414 within the GI portion 404 of the data packet 402).

For indoor scenarios, a first duration or less of delay spread 410 may be present and, in some implementations, the AP 102-a and/or the AP 102-b may employ time synchronization along with a second duration GI portion 404 (such as for enterprise and/or mesh networks), the second duration being greater than the first duration. In accordance with using the second duration of GI, the AP 102-a and/or the AP 102-b may have approximately a third duration of time synchronization margin (such that the “extra” GI 408 might be equal to the third duration), which may be achievable in some deployments (such as enterprise deployments and/or carrier or retail mesh deployments) through a timing synchronization function (TSF). As such, the AP 102-a and/or the AP 102-b may achieve approximately zero performance impact (and avoid adversely impacting actual data decoding at a STA 104, as any contributed interference may appear within the GI/CP 414 and/or the GI Portion 404).

In some scenarios (such as in some retail scenarios), if the AP 102-a (a BSS AP 102) uses a relatively short GI portion 404 (such as a fourth duration or less, the fourth duration being approximately less than or equal to the first duration or otherwise within a threshold range of the first duration), the AP 102-a and the AP 102-b may be unable to achieve a sufficient time synchronization. For example, the “extra” GI 408 may be less than or equal to a lower limit threshold at which point the AP 102-a might be unable to consistently place OBSS spikes within the GI/CP 414 of the data packet 412, or at which point the AP 102-b might be unable to consistently place OBSS spikes within the GI portion 404. In such scenarios, the AP 102-a and/or the AP 102-b may use reduced transmission power on a coordinated beamforming (such as an aCoBF) transmission. Such use of a reduced transmission power on a coordinated beamforming transmission may satisfy one or more targets sometimes associated with OBSS PD based SR, although the AP 102-a and/or the AP 102-b may apply significantly less transmit power reduction to an aCoBF transmission as compared to OBSS PD based SR because some amount (such as most) interference may be nulled-out (such as avoided or reduced) via beamforming.

In some implementations, the AP 102-a may receive an indication of the GI/CP 414 (such as the GI duration) used by the AP 102-b and may select a transmission power for the data portion of the data packet 402 in accordance with whether the GI/CP 414 is greater than or equal to a threshold time duration. For example, if a GI duration of a transmission by the AP 102-b is less than the threshold time duration, the AP 102-a may ascertain or otherwise determine that time synchronization with the AP 102-b is unlikely or insufficient and may use a relatively lower transmission power to send the data portion (to avoid or reduce the interference 204-a). Alternatively, if a GI duration of the transmission by the AP 102-b is greater than or equal to the threshold time duration, the AP 102-a may ascertain or otherwise determine that time synchronization with the AP 102-b is likely or sufficient and may use a relatively higher transmission power to send the data portion (as much of the interference 204-a is likely or predicted to fall within the GI/CP 414).

Further, although described in the context of the relatively lower transmission power being used if the GI duration is less than the threshold time duration, the relatively lower transmission power also may be used if the GI duration is less than or equal to the threshold time duration. Similarly, although described in the context of the relatively higher transmission power being used if the GI duration is greater than or equal to the threshold time duration, the relatively higher transmission power may alternatively be used if the GI duration is greater than the threshold time duration. Alternatively, in some other implementations, the relatively lower transmission power also may be used regardless of whether the GI duration is greater than or less than the threshold time duration, or the relatively higher transmission power may be used regardless of whether the GI duration is greater than or less than the threshold time duration. In such implementations, for example, use of the relatively lower transmission power or the relatively higher transmission power may be conditioned or dependent on one or more other factors in addition, or as an alternative, to whether the GI duration is greater than or less than the threshold time duration.

In implementations in which the AP 102-a ascertains or otherwise determines that time synchronization with the AP 102-b is unlikely or insufficient, the AP 102-a may select a transmission power in accordance with one or more OBSS receive signal strength measurements, such as OBSS receive signal strength indicator (RSSI) or other signal strength channel measurements. For example, the AP 102-a may obtain information indicative of a signal strength at the STA 104-b (such as a signal strength attributable to the interference 204-a) and, if time synchronization between the AP 102-a and the AP 102-b is unlikely or insufficient, the AP 102-a may select a transmission power in accordance with the signal strength at the STA 104-b. In some examples, the AP 102-a may select a transmission power such that a measured or predicted signal strength at the STA 104-b is less than or equal to a threshold signal strength.

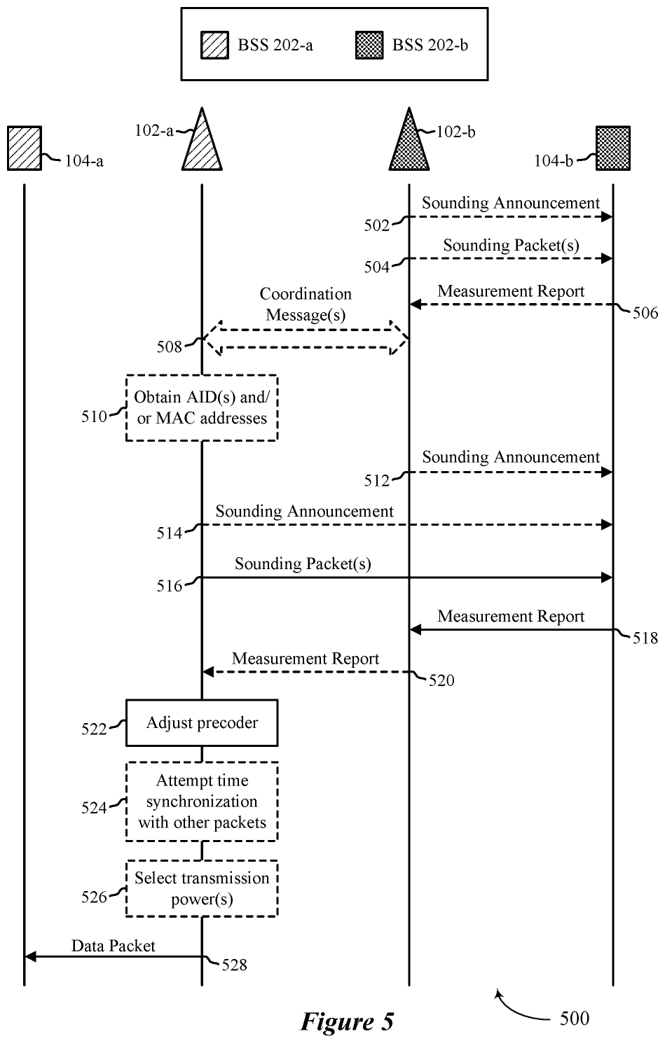

FIG. 5 shows an example process flow 500 that supports interference reduction between wireless communication devices of OBSSs. The process flow 500 may implement or be implemented to realize aspects of the wireless communication network 100, the wireless communication system 200, one or both of the communication timelines 300 and 301, or the signaling diagram 400. For example, the process flow 500 illustrates communication between an AP 102-a, an AP 102-b, a STA 104-a, and a STA 104-b, which may be examples of the AP 102-a, the AP 102-b, the STA 104-a, and the STA 104-b as illustrated by and described with reference to FIG. 2. In some implementations, the AP 102-a (of the BSS 202-a) may employ one or more signaling- or configuration-based mechanisms associated with obtaining downlink channel estimates to OBSS STAs 104 (such as the STA 104-b of the BSS 202-b), preamble interference mitigation, and/or reduced transmission power levels for coordinated beamforming transmissions in select scenarios.

In the following description of the process flow 500, the operations may be performed (such as reported or provided) in a different order than the order shown, or the operations performed by the example devices may be performed in different orders or at different times. Some operations also may be left out of the process flow 500, or other operations may be added to the process flow 500. Further, although some operations or signaling may be shown to occur at different times for discussion purposes, these operations may actually occur at the same time.

In some implementations, the AP 102-a may obtain or otherwise acquire information assistive of enabling an OBSS channel sounding operation between the AP 102-a of the BSS 202-a and the STA 104-b of the BSS 202-b. In some of such implementations, the AP 102-a may monitor a channel between the AP 102-b and the STA 104-b may communication that may be indicative of identifying information of (such as associated with) the AP 102-b and/or the STA 104-b. Such identifying information may include a TA associated with the AP 102-b, an AID of the STA 104-b, and/or a MAC address associated with the STA 104-b (along with AID values and/or MAC addresses associated with one or more other STAs 104 of the BSS 202-b).

For example, at 502, the AP 102-b may transmit a sounding announcement frame (such as an NDPA) to the STA 104-b, the sounding announcement frame including a TA associated with the AP 102-b and an AID of the STA 104-b. In such examples, the AP 102-a may obtain information indicative of one or both of the TA associated with the AP 102-b and/or the AID of the STA 104-b by “overhearing” the sounding announcement frame. In examples in which the AP 102-b and the STA 104-b participate in a channel sounding operation, at 504, the AP 102-b may transmit one or more sounding packets (such as one or more NDPs) to the STA 104-b. At 506, responsive to the sounding announcement frame, the one or more sounding packets, and optionally a trigger frame (such as a BFRP frame), the STA 104-b may transmit a measurement report (such as a CBF report) to the AP 102-b. The measurement report may include a MAC address associated with the STA 104-b (in, for example, an TA field of the measurement report) and, in some implementations, the AP 102-a may obtain information indicative of the MAC address associated with the STA 104-b in accordance with monitoring the channel between the AP 102-b and the STA 104-b.

Additionally, or alternatively, at 508, the AP 102-a and the AP 102-b may exchange (such as transmit and/or receive) one or more coordination messages. The AP 102-a and the AP 102-b may exchange the one or more coordination messages via a backhaul communication link between the AP 102-a and the AP 102-b. The one or more coordination messages may include information assistive of coordination between the AP 102-a and the AP 102-b. For example, the one or more coordination messages may indicate identifying information of the AP 102-b and/or the STA 104-b (such that the AP 102-a may avoid monitoring the channel between the AP 102-b and the STA 104-b to obtain such information) and/or timing information associated with a coordinated OBSS channel sounding operation. For example, the one or more coordination messages may indicate a timing of a sounding announcement frame and/or a triggering frame, such as a BFRP frame, to be sent by the AP 102-b, which the AP 102-a may use to schedule a transmission of one or more NDPs as part of the OBSS channel sounding operation.

The one or more coordination messages may include any type of message, frame, or packet, including capability reporting signaling, configuration signaling, MAC layer signaling, or PHY layer signaling. For example, the AP 102-a and/or the AP 102-b may indicate respective capabilities associated with NDPA and/or NDP spoofing via the one or more coordination messages. Additionally, or alternatively, the AP 102-a and/or the AP 102-b may indicate a (MAC or PHY layer) activation and/or deactivation of NDPA and/or NDP spoofing via the one or more coordination messages. Further, in some implementations, the AP 102-a and/or the AP 102-b may indicate respective capabilities associated with data packet power control (such as a capability for portion-by-portion power control) via the one or more coordination messages. Additionally, or alternatively, the AP 102-a and/or the AP 102-b may indicate a (MAC or PHY layer) activation and/or deactivation of portion-by-portion power control.

At 510, the AP 102-a may obtain the identifying information associated with the AP 102-b and/or the STA 104-b (along with any other STAs 104 in the BSS 202-b). For example, the AP 102-a may obtain such identifying information (including AID values and/or MAC addresses) by monitoring channel sounding operations between the AP 102-b and the STA 104-b and/or via information conveyed by the one or more coordination messages.

In accordance with obtaining the identifying information and/or the timing information associated with an OBSS channel sounding operation, the AP 102-a may participate in an OBSS channel sounding operation between the AP 102-a and the STA 104-b by “spoofing” one or more sounding frames or packets such that the “spoofed” sounding frames or packets appear as if they were transmitted by the AP 102-b. In some implementations, the AP 102-a and the AP 102-b may employ a “coordinated spoofing” variant of the OBSS channel sounding operation. In some other implementations, the AP 102-a may employ a “full spoofing” variant of the OBSS channel sounding operation.

At 512, in implementations in which the AP 102-a and the AP 102-b employ a “coordinated spoofing” variant of the OBSS channel sounding operation, the AP 102-b may transmit a sounding announcement frame (such as an NDPA frame). The sounding announcement frame may address (via an AID value) the STA 104-b. As such, the STA 104-b may be expected to measure and report channel information associated with a set of sounding packets received after the sounding announcement frame.

At 514, in implementations in which the AP 102-a employs a “full spoofing” variant of the OBSS channel sounding operation, the AP 102-a may transmit the sounding announcement frame (such as the NDPA frame) addressing (via the AID value) the STA 104-b. In such implementations, the AP 102-a may “spoof” the sounding announcement frame by including a TA value indicative of the AP 102-b in the sounding announcement frame. As such, the STA 104-b may receive the sounding announcement frame, recognize the TA value as being indicative of the AP 102-b, and be expected to measure and report channel information associated with a set of sounding packets received after the sounding announcement frame.

At 516, the AP 102-a may transmit the set of sounding packets. In some implementations, the AP 102-a may transmit the set of sounding packets in accordance with the channel sounding operation at the STA 104-b (as initiated by the sounding announcement frame transmitted either at 512 or at 514). Further, in some implementations, the AP 102-a may associate the set of sounding packets with one or more parameters indicative of the BSS 202-b with which the STA 104-b is associated. Such an association of the set of sounding packets with the one or more parameters indicative of the BSS 202-b may take various forms. In some examples, the AP 102-a may associate the set of sounding packets with the one or more parameters indicative of the BSS 202-b in accordance with including, in each of the sounding packets, a value in a BSS color subfield that is indicative of the BSS 202-b. In such examples, the set of sounding packets may be HE or EHT sounding packets (such as HE or EHT NDPs). Additionally, or alternatively, the AP 102-a may associate the set of sounding packets with the one or more parameters indicative of the BSS 202-b in accordance with an immediately prior (as defined by, for example, a SIFS duration) sounding announcement frame including the one or more parameters. For example, if the immediately prior sounding announcement frame includes a TA indicative of the AP 102-b, the sounding packets transmitted subsequent to that sounding announcement frame may be understood as being associated with the TA because the STA 104-b may interpret or expect the sounding packets to be transmitted by the device to which the TA corresponds. As such, for NDPA and/or NDP spoofing, the AP 102-a may transmit a sounding announcement frame and/or sounding packets using a TA and/or BSS color, respectively, different than its own. Further, in some implementations, the AP 102-a may participate in one or more in-BSS channel sounding operations. In such implementations, the AP 102-a may toggle a TA field in a sounding announcement frame and/or toggle a BSS color field in a sounding packet over time as the AP 102-a switches between in-BSS channel sounding and (spoofed) OBSS channel sounding.

In accordance with the sounding packets being associated with at least one parameter indicative of the BSS 202-b to which the STA 104-b belongs, the STA 104-b may measure and report CSI associated with the sounding packets. At 518, for example, the STA 104-b may transmit a measurement report including CSI associated with a channel between the AP 102-a and the STA 104-b. In some examples, the STA 104-b may transmit the measurement report to the AP 102-b because the STA 104-b may operate in accordance with an expectation or assumption that the AP 102-b transmitted the sounding announcement frame and the sounding packets. The AP 102-a may obtain the CSI in various manners. In some implementations, the AP 102-a may obtain the CSI in accordance with monitoring the channel between the AP 102-b and the STA 104-b (and “overhearing” the measurement report transmitted by the STA 104-b). Additionally, or alternatively, the AP 102-b may forward or relay the CSI from the STA 104-b to the AP 102-a via a backhaul communication link between the AP 102-a and the AP 102-b.

At 520, for example, the AP 102-b may transmit a forwarded or relayed version of the measurement report to the AP 102-a via the backhaul communication link. The AP 102-a may receive the CSI and, in some implementations, may use the CSI as part of a coordinated beamforming transmission. For example, the AP 102-a may transmit a data message in accordance with the received CSI to reduce, minimize, mitigate, or avoid causing interference toward the STA 104-b.

At 522, for example, the AP 102-a may adjust (such as set) a precoder of the AP 102-a in accordance with the received CSI. In some implementations, adjusting the precoder of the AP 102-a may include adjusting one or more precoding weights to configure or orient a directional transmission by the AP 102-a (which may be understood herein as a beamformed transmission). In some implementations, the AP 102-a may adjust the precoder in accordance with both a directivity gain toward the STA 104-a and the CSI associated with the channel between the AP 102-a and the STA 104-b to achieve a balance between directivity gain toward the STA 104-a and interference reduction toward the STA 104-b. Additionally, or alternatively, the AP 102-a may adjust the precoder such that the precoder is at least approximately orthogonal to a transmission vector associated with the CSI of the channel between the AP 102-a and the STA 104-b. In accordance with setting the precoder to be nearly or approximately orthogonal (instead of exactly orthogonalizing) to the transmission vector associated with the CSI of the channel between the AP 102-a and the STA 104-b, the AP 102-a may reduce interference to OBSS STA(s) 104 and provide a relatively high signal-to-noise ratio (SNR) to STAs 104 served by the AP 102-a (such as the STA 104-a). Further, in some implementations, the AP 102-a may create nulls (or otherwise reduce interference toward) OBSS STAs 104 that are currently being scheduled by the AP 102-b for simultaneous or at least partially overlapping transmissions with the data packet to be transmitted by the AP 102-a. Likewise, the AP 102-a may refrain from creating nulls toward OBSS STAs 104 that are not being scheduled by the AP 102-b for simultaneous or at least partially overlapping transmissions.

At 524, in some implementations, the AP 102-a and the AP 102-b may attempt time synchronization. For example, the AP 102-a may attempt to time synchronize with one or more other packets transmitted by the AP 102-b. The AP 102-a and the AP 102-b may be relatively more likely to sufficiently time synchronize their respective transmissions if a GI duration used by one of the AP 102-a and the AP 102-b is greater than or equal to a threshold duration. In some implementations, the AP 102-a may select a transmission power for a data portion of the data packet in accordance with an amount or level of time synchronization between the AP 102-a and the AP 102-b.

At 526, for example, the AP 102-a may select a relatively lower transmission power (and may further select the relatively lower transmission power in accordance with one or more OBSS signal strength measurements or predictions at the STA 104-b) if the AP 102-a and the AP 102-b are relatively unsynchronized. Alternatively, the AP 102-a may select a relatively higher transmission power if the AP 102-a and the AP 102-b are relatively synchronized (such as synchronized within a threshold time margin). Further, in some implementations, the AP 102-a may select a transmission power for a preamble portion of the data packet. In some examples, the AP 102-a may select a transmission power for the preamble portion of the data packet in accordance with whether the preamble portion is beamformed. For example, if the preamble portion is beamformed, the AP 102-a may select a relatively higher transmission power. Alternatively, if the preamble portion is non-beamformed, the AP 102-a may select a relatively lower transmission power.

At 528, the AP 102-a may transmit, in accordance with the CSI associated with the channel between the AP 102-a and the STA 104-b, a data packet to the STA 104-a. To transmit the data packet to the STA 104-a, the AP 102-a may include an RA value indicative of the STA 104-a in the data packet. In some scenarios, the AP 102-a may transmit the data packet to multiple STAs 104 including the STA 104-a by including multiple RAs in the data packet or by including an RA that addresses multiple STAs 104 (such as a broadcast RA). The AP 102-a may transmit different portions of the data packet using potentially different transmission powers in accordance with a level of beamforming, a level of time synchronization between the AP 102-a and the AP 102-b, and/or one or more OBSS signal strength measurements or predictions. For example, the AP 102-a may transmit a first portion (such as the preamble portion) of the data packet using a first transmission power and may transmit a second portion (such as the data portion) of the data packet using a second transmission power. In some examples, the first transmission power may be the same as the second transmission power. In some other examples, the first transmission power and the second transmission power may be different.

In some aspects, the AP 102-a may select the first transmission power in accordance with whether the first portion of the data packet is beamformed. If the first portion of the data packet is not beamformed, the AP 102-a may use a relatively lower transmission power to transmit the first portion of the data packet. If the first portion of the data packet is beamformed, the AP 102-a may use a relatively higher transmission power to transmit the first portion of the data packet. The AP 102-a may select the second transmission power in accordance with a level of time synchronization between transmissions by the AP 102-a and transmissions by the AP 102-b. In some implementations, the level of time synchronization may be dependent on a GI duration of transmissions by the AP 102-b. If relatively sufficient time synchronization is achievable, the AP 102-a may use a relatively higher transmission power to transmit the second portion. If relatively sufficient time synchronization is not achievable (or at least not likely achievable), the AP 102-a may use a relatively lower transmission power to transmit the second portion. In accordance with such portion-by-portion power control, an RSSI of the data packet may change or vary across the packet. In other words, portion-by-portion power control may result in a unique RSSI profile of the data packet at a measuring device.

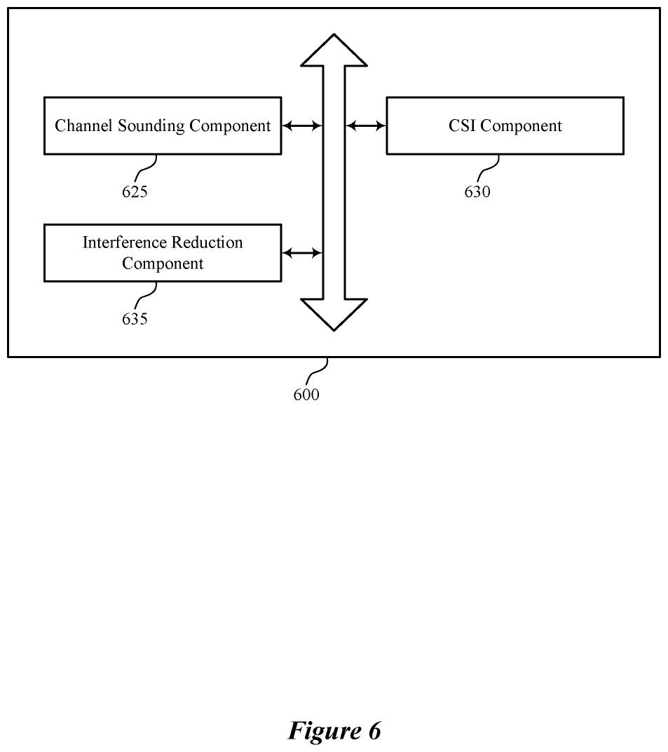

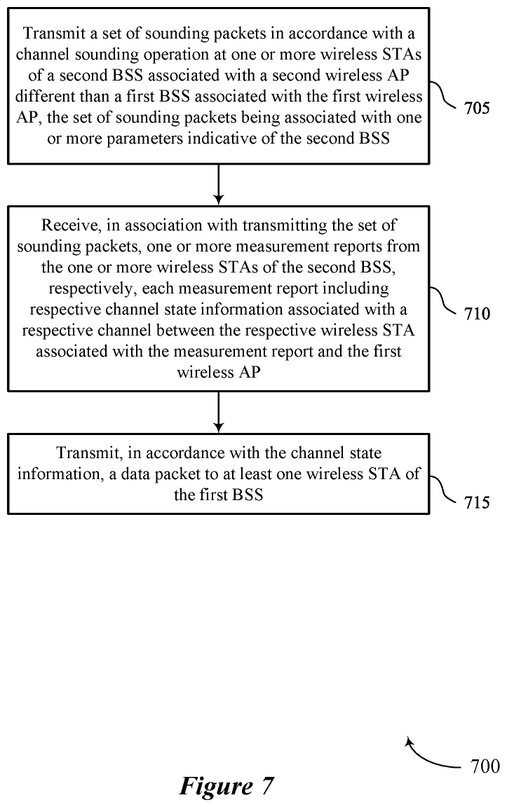

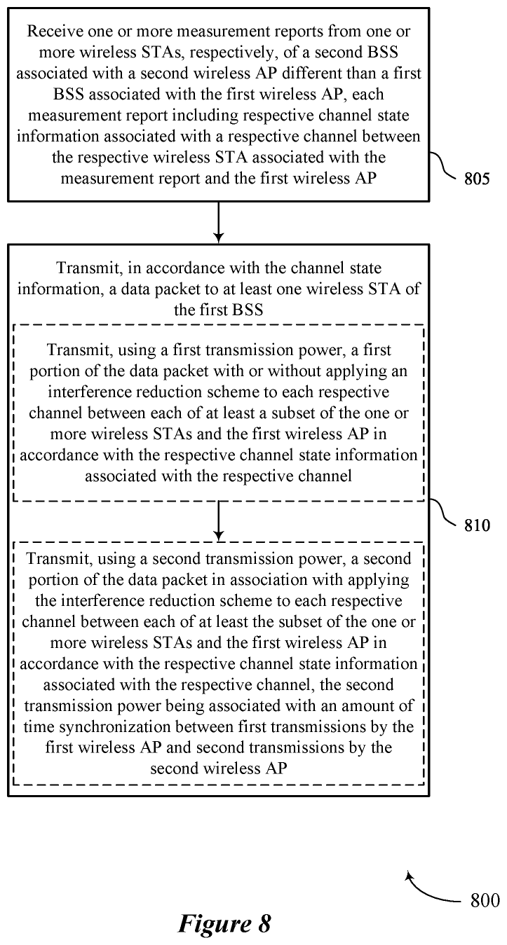

FIG. 6 shows a block diagram of an example wireless communication device 600 that supports interference reduction between wireless communication devices of OBSSs. In some examples, the wireless communication device 600 is configured to perform the processes 700 and 800 described with reference to FIGS. 7 and 8, respectively. The wireless communication device 600 may include one or more chips, SoCs, chipsets, packages, components or devices that individually or collectively constitute or include a processing system. The processing system may interface with other components of the wireless communication device 600, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 600 may transmit the information output from the chip. In such an example, the second interface may refer to an interface between the processing system of the chip and a reception component, such that the wireless communication device 600 may receive information that is then passed to the processing system. In some such examples, the first interface also may obtain information, such as from the transmission component, and the second interface also may output information, such as to the reception component.

The processing system of the wireless communication device 600 includes processor (or “processing”) circuitry in the form of one or multiple processors, microprocessors, processing units (such as central processing units (CPUs), graphics processing units (GPUs) or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 600 can configurable or configured for use in an AP, such as the AP 102 described with reference to FIG. 1. In some other examples, the wireless communication device 600 can be an AP that includes such a processing system and other components including multiple antennas. The wireless communication device 600 is capable of transmitting and receiving wireless communication in the form of, for example, wireless packets. For example, the wireless communication device 600 can be configured, configurable, or operable to transmit and receive packets in the form of physical layer PPDUs and MPDUs conforming to one or more of the IEEE 802.11 family of wireless communication protocol standards. In some other examples, the wireless communication device 600 can be configurable or configured to transmit and receive signals and communication conforming to one or more 3GPP specifications including those for 5G NR or 6G. In some examples, the wireless communication device 600 also includes or can be coupled with one or more application processors which may be further coupled with one or more other memories. In some examples, the wireless communication device 600 further includes at least one external network interface coupled with the processing system that enables communication with a core network or backhaul network that enables the wireless communication device 600 to gain access to external networks including the Internet.

The wireless communication device 600 includes a channel sounding component 625, a CSI component 630, and an interference reduction component 635. Portions of one or more of the channel sounding component 625, the CSI component 630, and the interference reduction component 635 may be implemented at least in part in hardware or firmware. For example, one or more of the channel sounding component 625, the CSI component 630, and the interference reduction component 635 may be implemented at least in part by at least a processor or a modem. In some examples, portions of one or more of the channel sounding component 625, the CSI component 630, and the interference reduction component 635 may be implemented at least in part by a processor and software in the form of processor-executable code stored in memory.

The wireless communication device 600 may support wireless communication in accordance with examples as disclosed herein. The channel sounding component 625 is configurable or configured to transmit a set of sounding packets in accordance with a channel sounding operation at one or more wireless STAs of a second BSS associated with a second wireless AP different than a first BSS associated with the first wireless AP, the set of sounding packets being associated with one or more parameters indicative of the second BSS. The CSI component 630 is configurable or configured to receive, in association with transmitting the set of sounding packets, one or more measurement reports from the one or more wireless STAs of the second BSS, respectively, each measurement report including respective channel state information associated with a respective channel between the respective wireless STA associated with the measurement report and the first wireless AP. The interference reduction component 635 is configurable or configured to transmit, in accordance with the channel state information, a data packet to at least one wireless STA of the first BSS.

In some examples, each sound packet of the set of sounding packets includes at least one parameter, of the one or more parameters, indicative of the second BSS.

In some examples, the at least one parameter be associated with a value of a BSS color subfield, the value of the BSS color subfield being indicative of the second BSS.

In some examples, the channel sounding component 625 is configurable or configured to transmit a sounding announcement frame prior to transmitting the set of sounding packets, the sounding announcement frame including the one or more parameters indicative of the second BSS, where the set of sounding packets are associated with the one or more parameters in accordance with the sounding announcement frame including the one or more parameters.

In some examples, the one or more parameters include a transmitter address associated with the sounding announcement frame, the transmitter address being indicative of the second wireless AP associated with the second BSS.

In some examples, to support receiving the one or more measurement reports, the CSI component 630 is configurable or configured to monitor one or more second channels between the one or more wireless STAs, respectively, and the second wireless AP associated with the second BSS, where the one or more measurement reports are received via the one or more second channels, respectively.

In some examples, the CSI component 630 is configurable or configured to receive the one or more measurement reports from the second wireless AP associated with the second BSS via a backhaul wireless communication link between the first wireless AP and the second wireless AP.

In some examples, the channel sounding component 625 is configurable or configured to exchange one or more coordination messages with the second wireless AP associated with the second BSS, where at least one of the one or more coordination messages is indicative of a time at which the second wireless AP is to transmit one or both of a sounding announcement frame and a beamforming report poll frame associated with the channel sounding operation, and where the set of sounding packets are transmitted by the first wireless AP subsequent to the time at which the second wireless AP is to transmit the sounding announcement frame, and where the set of sounding packets are transmitted by the first wireless AP prior to the time at which the second wireless AP is to transmit the beamforming report poll frame.

In some examples, the channel sounding component 625 is configurable or configured to transmit one or both of a sounding announcement frame and a beamforming report poll frame associated with the channel sounding operation, where the sounding announcement frame and the beamforming report poll frame are associated with one or more second parameters indicative of the second BSS, and where transmitting the set of sounding packets is in association with transmitting one or both of the sounding announcement frame and the beamforming report poll frame.

In some examples, the one or more second parameters include a transmitter address associated with one or both of the sounding announcement frame and the beamforming report poll frame, the transmitter address being indicative of the second wireless AP associated with the second BSS.

In some examples, the transmission of the set of sound packets is in association with the transmission of the sounding announcement frame, and the reception of the one or more measurement reports is in association with the transmission of the beamforming report poll frame.

In some examples, the channel sounding component 625 is configurable or configured to receive information indicative of one or more AID values corresponding to the one or more wireless STAs of the second BSS. In some examples, the channel sounding component 625 is configurable or configured to transmit one or both of the sounding announcement frame and the beamforming report poll frame in association with setting a transmitter address of one or both of the sounding announcement frame and the beamforming report poll frame to be indicative of the second wireless AP and including, in one or both of the sounding announcement frame and the beamforming report poll frame, the one or more AID values corresponding to the one or more wireless STAs of the second BSS, where the one or more second parameters that are indicative of the second BSS include the transmitter address indicative of the second wireless AP and the one or more AID values corresponding to the one or more wireless STAs of the second BSS.

In some examples, the channel sounding component 625 is configurable or configured to receive an indication of each of the one or more AID values from the second wireless AP via a backhaul wireless communication link between the first wireless AP and the second wireless AP.

In some examples, the channel sounding component 625 is configurable or configured to receive the information indicative of the one or more AID values via one or more sounding announcement frames transmitted by the second wireless AP in association with monitoring respective second channels between each of the one or more wireless STAs and the second wireless AP.

In some examples, the interference reduction component 635 is configurable or configured to transmit the data packet in association with applying an interference reduction scheme to the respective channels between each of the one or more wireless STAs of the second BSS and the first wireless AP, where applying the interference reduction scheme to the respective channels is associated with the respective channel state information and a MAC address of each of the one or more wireless STAs.

In some examples, the interference reduction component 635 is configurable or configured to set a precoder of the first wireless AP in accordance with the respective channel state information associated with the respective channels between each of the one or more wireless STAs and the first wireless AP, where the application of the interference reduction scheme is in association with the setting of the precoder.

In some examples, the channel sounding component 625 is configurable or configured to receive, via one or more second measurement reports, information indicative of one or more MAC addresses corresponding to the one or more wireless STAs.

In some examples, the one or more second measurement reports be associated with one or more first sounding announcement frames transmitted by the first wireless AP or one or more second sounding announcement frames transmitted by the second wireless AP, the one or more first sounding announcement frames or the one or more second sounding announcement frames being associated with one or more second parameters indicative of the second BSS.

In some examples, the interference reduction component 635 is configurable or configured to transmit, using a first transmission power, a first portion of the data packet with or without applying an interference reduction scheme to each respective channel between each of at least a subset of the one or more wireless STAs and the first wireless AP in accordance with the respective channel state information associated with the respective channel. In some examples, the interference reduction component 635 is configurable or configured to transmit, using a second transmission power, a second portion of the data packet in association with applying the interference reduction scheme to each respective channel between each of at least the subset of the one or more wireless STAs and the first wireless AP in accordance with the respective channel state information associated with the respective channel, the second transmission power being associated with an amount of time synchronization between first transmissions by the first wireless AP and second transmissions by the second wireless AP.

In some examples, the first portion of the data packet may be a non-beamformed portion of the data packet and the second portion of the data packet is a beamformed portion of the data packet. In some examples, the second portion be beamformed in accordance with the respective channel state information associated with each respective channel between each of at least the subset of the one or more wireless STAs and the first wireless AP.

In some examples, the interference reduction component 635 is configurable or configured to receive an indication of a guard interval duration used by the second wireless AP. In some examples, the interference reduction component 635 is configurable or configured to transmit the second portion of the data packet using a relatively lower transmission power or a relatively higher transmission power in accordance with whether the guard interval duration used by the second wireless AP is greater than or equal to a threshold time duration, where the second transmission power is one of the relatively lower transmission power and the relatively higher transmission power.

In some examples, the threshold time duration be equal to a sum of a delay spread of a channel between the first wireless AP and the at least one wireless STA and a lag time between first transmissions by the first wireless AP and second transmissions by the second wireless AP.

In some examples, the relatively lower transmission power be used for the second portion of the data packet if the guard interval duration is less than the threshold time duration and the relatively higher transmission power is used for the second portion of the data packet if the guard interval duration is greater than or equal to the threshold time duration.

In some examples, the interference reduction component 635 is configurable or configured to receive an indication of one or more received signal strengths at each of the one or more wireless STAs associated with one or more transmissions by the first wireless AP. In some examples, the interference reduction component 635 is configurable or configured to transmit the data packet using a transmission power that is selected in accordance with whether the one or more received signal strengths satisfy a threshold received signal strength.

In some examples, the first BSS be an OBSS relative to the second BSS.

Additionally, or alternatively, the wireless communication device 600 may support wireless communication in accordance with examples as disclosed herein. In some examples, the CSI component 630 is configurable or configured to receive one or more measurement reports from one or more wireless STAs, respectively, of a second BSS associated with a second wireless AP different than a first BSS associated with the first wireless AP, each measurement report including respective channel state information associated with a respective channel between the respective wireless STA associated with the measurement report and the first wireless AP. In some examples, the interference reduction component 635 is configurable or configured to transmit, in accordance with the channel state information, a data packet to at least one wireless STA of the first BSS and the method further including. In some examples, the interference reduction component 635 is configurable or configured to transmit, using a first transmission power, a first portion of the data packet with or without applying an interference reduction scheme to each respective channel between each of at least a subset of the one or more wireless STAs and the first wireless AP in accordance with the respective channel state information associated with the respective channel. In some examples, the interference reduction component 635 is configurable or configured to transmit, using a second transmission power, a second portion of the data packet in association with applying the interference reduction scheme to each respective channel between each of at least the subset of the one or more wireless STAs and the first wireless AP in accordance with the respective channel state information associated with the respective channel, the second transmission power being associated with an amount of time synchronization between first transmissions by the first wireless AP and second transmissions by the second wireless AP.

In some examples, the interference reduction component 635 is configurable or configured to receive an indication of a guard interval duration used by the second wireless AP. In some examples, the interference reduction component 635 is configurable or configured to transmit the second portion of the data packet using a relatively lower transmission power or a relatively higher transmission power in accordance with whether the guard interval duration used by the second wireless AP is greater than or equal to a threshold time duration, where the second transmission power is one of the relatively lower transmission power and the relatively higher transmission power.

In some examples, the threshold time duration be equal to a sum of a delay spread of a channel between the first wireless AP and the at least one wireless STA and a lag time between the first transmissions by the first wireless AP and the second transmissions by the second wireless AP.

In some examples, the relatively lower transmission power be used for the second portion of the data packet if the guard interval duration is less than the threshold time duration and the relatively higher transmission power is used for the second portion of the data packet if the guard interval duration is greater than or equal to the threshold time duration.

In some examples, the guard interval duration be less than the threshold time duration, and the relatively lower transmission power is a function of one or more received signal strengths at each of the one or more wireless STAs associated with one or more transmissions by the first wireless AP.

In some examples, the second transmission power may be higher than the first transmission power in accordance with the interference reduction scheme being applied to the second portion of the data packet and being absent from the first portion of the data packet.

In some examples, the first portion of the data packet may be a non-beamformed portion of the data packet and the second portion of the data packet is a beamformed portion of the data packet, and the second portion is beamformed in accordance with the respective channel state information associated with each respective channel between each of at least the subset of the one or more wireless STAs and the first wireless AP.

In some examples, the first BSS be an OBSS relative to the second BSS.

FIG. 7 shows a flowchart illustrating an example process 700 performable by or at a wireless AP that supports interference reduction between wireless communication devices of OBSSs. The operations of the process 700 may be implemented by a wireless AP or its components as described herein. For example, the process 700 may be performed by a wireless communication device, such as the wireless communication device 600 described with reference to FIG. 6, operating as or within a wireless AP. In some examples, the process 700 may be performed by a wireless AP, such as one of the APs 102 described with reference to FIG. 1.

In some examples, in block 705, the first wireless AP may transmit a set of sounding packets in accordance with a channel sounding operation at one or more wireless STAs of a second BSS associated with a second wireless AP different than a first BSS associated with the first wireless AP, the set of sounding packets being associated with one or more parameters indicative of the second BSS. The operations of block 705 may be performed in accordance with examples as disclosed herein. In some implementations, aspects of the operations of block 705 may be performed by a channel sounding component 625 as described with reference to FIG. 6.

In some examples, in block 710, the first wireless AP may receive, in association with transmitting the set of sounding packets, one or more measurement reports from the one or more wireless STAs of the second BSS, respectively, each measurement report including respective channel state information associated with a respective channel between the respective wireless STA associated with the measurement report and the first wireless AP. The operations of block 710 may be performed in accordance with examples as disclosed herein. In some implementations, aspects of the operations of block 710 may be performed by a CSI component 630 as described with reference to FIG. 6.

In some examples, in block 715, the first wireless AP may transmit, in accordance with the channel state information, a data packet to at least one wireless STA of the first BSS. The operations of block 715 may be performed in accordance with examples as disclosed herein. In some implementations, aspects of the operations of block 715 may be performed by an interference reduction component 635 as described with reference to FIG. 6.

FIG. 8 shows a flowchart illustrating an example process 800 performable by or at a wireless AP that supports interference reduction between wireless communication devices of OBSSs. The operations of the process 800 may be implemented by a wireless AP or its components as described herein. For example, the process 800 may be performed by a wireless communication device, such as the wireless communication device 600 described with reference to FIG. 6, operating as or within a wireless AP. In some examples, the process 800 may be performed by a wireless AP, such as one of the APs 102 described with reference to FIG. 1.

In some examples, in block 805, the first wireless AP may receive one or more measurement reports from one or more wireless STAs, respectively, of a second BSS associated with a second wireless AP different than a first BSS associated with the first wireless AP, each measurement report including respective channel state information associated with a respective channel between the respective wireless STA associated with the measurement report and the first wireless AP. The operations of block 805 may be performed in accordance with examples as disclosed herein. In some implementations, aspects of the operations of block 805 may be performed by a CSI component 630 as described with reference to FIG. 6.

In some examples, in block 810, the first wireless AP may transmit, in accordance with the channel state information, a data packet to at least one wireless STA of the first BSS. In some examples, transmitting the data packet may include transmitting, using a first transmission power, a first portion of the data packet with or without applying an interference reduction scheme to each respective channel between each of at least a subset of the one or more wireless STAs and the first wireless AP in accordance with the respective channel state information associated with the respective channel. In some examples, transmitting the data packet may further include transmitting, using a second transmission power, a second portion of the data packet in association with applying the interference reduction scheme to each respective channel between each of at least the subset of the one or more wireless STAs and the first wireless AP in accordance with the respective channel state information associated with the respective channel, the second transmission power being associated with an amount of time synchronization between first transmissions by the first wireless AP and second transmissions by the second wireless AP. The operations of block 810 may be performed in accordance with examples as disclosed herein. In some implementations, aspects of the operations of block 810 may be performed by an interference reduction component 635 as described with reference to FIG. 6.

Implementation examples are described in the following numbered clauses:

Clause 1: A method for wireless communication by a first wireless AP, including: transmitting a set of sounding packets in accordance with a channel sounding operation at one or more wireless STAs of a second BSS associated with a second wireless AP different than a first BSS associated with the first wireless AP, the set of sounding packets being associated with one or more parameters indicative of the second BSS; receiving, in association with transmitting the set of sounding packets, one or more measurement reports from the one or more wireless STAs of the second BSS, respectively, each measurement report including respective channel state information associated with a respective channel between the respective wireless STA associated with the measurement report and the first wireless AP; and transmitting, in accordance with the channel state information, a data packet to at least one wireless STA of the first BSS.

Clause 2: The method of clause 1, where each sounding packet of the set of sounding packets includes at least one parameter, of the one or more parameters, indicative of the second BSS.

Clause 3: The method of clause 2, where the at least one parameter is associated with a value of a BSS color subfield, the value of the BSS color subfield being indicative of the second BSS.

Clause 4: The method of any of clauses 1 through 3, further including: transmitting a sounding announcement frame prior to transmitting the set of sounding packets, the sounding announcement frame including the one or more parameters indicative of the second BSS, where the set of sounding packets are associated with the one or more parameters in accordance with the sounding announcement frame including the one or more parameters.

Clause 5: The method of clause 4, where the one or more parameters include a transmitter address associated with the sounding announcement frame, the transmitter address being indicative of the second wireless AP associated with the second BSS.

Clause 6: The method of any of clauses 1 through 5, where receiving the one or more measurement reports includes: monitoring one or more second channels between the one or more wireless STAs, respectively, and the second wireless AP associated with the second BSS, where the one or more measurement reports are received via the one or more second channels, respectively.

Clause 7: The method of any of clauses 1 through 6, further including: receiving the one or more measurement reports from the second wireless AP associated with the second BSS via a backhaul wireless communication link between the first wireless AP and the second wireless AP.

Clause 8: The method of any of clauses 1 through 7, further including: exchanging one or more coordination messages with the second wireless AP associated with the second BSS, where at least one of the one or more coordination messages is indicative of a time at which the second wireless AP is to transmit one or both of a sounding announcement frame and a beamforming report poll frame associated with the channel sounding operation, and where the set of sounding packets are transmitted by the first wireless AP subsequent to the time at which the second wireless AP is to transmit the sounding announcement frame, and where the set of sounding packets are transmitted by the first wireless AP prior to the time at which the second wireless AP is to transmit the beamforming report poll frame.

Clause 9: The method of any of clauses 1 through 8, further including: transmitting one or both of a sounding announcement frame and a beamforming report poll frame associated with the channel sounding operation, where the sounding announcement frame and the beamforming report poll frame are associated with one or more second parameters indicative of the second BSS, and where transmitting the set of sounding packets is in association with transmitting one or both of the sounding announcement frame and the beamforming report poll frame.

Clause 10: The method of clause 9, where the one or more second parameters include a transmitter address associated with one or both of the sounding announcement frame and the beamforming report poll frame, the transmitter address being indicative of the second wireless AP associated with the second BSS.

Clause 11: The method of any of clauses 9 through 10, where the transmission of the set of sounding packets is in association with the transmission of the sounding announcement frame, and the reception of the one or more measurement reports is in association with the transmission of the beamforming report poll frame.

Clause 12: The method of any of clauses 9 through 11, further including: receiving information indicative of one or more AID values corresponding to the one or more wireless STAs of the second BSS; and transmitting one or both of the sounding announcement frame and the beamforming report poll frame in association with setting a transmitter address of one or both of the sounding announcement frame and the beamforming report poll frame to be indicative of the second wireless AP and including, in one or both of the sounding announcement frame and the beamforming report poll frame, the one or more AID values corresponding to the one or more wireless STAs of the second BSS, where the one or more second parameters that are indicative of the second BSS include the transmitter address indicative of the second wireless AP and the one or more AID values corresponding to the one or more wireless STAs of the second BSS.

Clause 13: The method of clause 12, further including: receiving an indication of each of the one or more AID values from the second wireless AP via a backhaul wireless communication link between the first wireless AP and the second wireless AP.

Clause 14: The method of any of clauses 12 through 13, further including: receiving the information indicative of the one or more AID values via one or more sounding announcement frames transmitted by the second wireless AP in association with monitoring respective second channels between each of the one or more wireless STAs and the second wireless AP.

Clause 15: The method of any of clauses 1 through 14, further including: transmitting the data packet in association with applying an interference reduction scheme to the respective channels between each of the one or more wireless STAs of the second BSS and the first wireless AP, where applying the interference reduction scheme to the respective channels is associated with the respective channel state information and a MAC address of each of the one or more wireless STAs.

Clause 16: The method of clause 15, further including: setting a precoder of the first wireless AP in accordance with the respective channel state information associated with the respective channels between each of the one or more wireless STAs and the first wireless AP, where the application of the interference reduction scheme is in association with the setting of the precoder.

Clause 17: The method of any of clauses 15 through 16, further including: receiving, via one or more second measurement reports, information indicative of one or more MAC addresses corresponding to the one or more wireless STAs.

Clause 18: The method of clause 17, where the one or more second measurement reports are associated with one or more first sounding announcement frames transmitted by the first wireless AP or one or more second sounding announcement frames transmitted by the second wireless AP, the one or more first sounding announcement frames or the one or more second sounding announcement frames being associated with one or more second parameters indicative of the second BSS.

Clause 19: The method of any of clauses 1 through 18, further including: transmitting, using a first transmission power, a first portion of the data packet with or without applying an interference reduction scheme to each respective channel between each of at least a subset of the one or more wireless STAs and the first wireless AP in accordance with the respective channel state information associated with the respective channel; and transmitting, using a second transmission power, a second portion of the data packet in association with applying the interference reduction scheme to each respective channel between each of at least the subset of the one or more wireless STAs and the first wireless AP in accordance with the respective channel state information associated with the respective channel, the second transmission power being associated with an amount of time synchronization between first transmissions by the first wireless AP and second transmissions by the second wireless AP.

Clause 20: The method of clause 19, where the first portion of the data packet is a non-beamformed portion of the data packet and the second portion of the data packet is a beamformed portion of the data packet, and the second portion is beamformed in accordance with the respective channel state information associated with each respective channel between each of at least the subset of the one or more wireless STAs and the first wireless AP.

Clause 21: The method of any of clauses 19 through 20, further including: receiving an indication of a guard interval duration used by the second wireless AP; and transmitting the second portion of the data packet using a relatively lower transmission power or a relatively higher transmission power in accordance with whether the guard interval duration used by the second wireless AP is greater than or equal to a threshold time duration, where the second transmission power is one of the relatively lower transmission power and the relatively higher transmission power.

Clause 22: The method of clause 21, where the threshold time duration is equal to a sum of a delay spread of a channel between the first wireless AP and the at least one wireless STA and a lag time between first transmissions by the first wireless AP and second transmissions by the second wireless AP.

Clause 23: The method of any of clauses 21 through 22, where the relatively lower transmission power is used for the second portion of the data packet if the guard interval duration is less than the threshold time duration and the relatively higher transmission power is used for the second portion of the data packet if the guard interval duration is greater than or equal to the threshold time duration.

Clause 24: The method of any of clauses 1 through 23, further including: receiving an indication of one or more received signal strengths at each of the one or more wireless STAs associated with one or more transmissions by the first wireless AP; and transmitting the data packet using a transmission power that is selected in accordance with whether the one or more received signal strengths satisfy a threshold received signal strength.

Clause 25: The method of any of clauses 1 through 24, where the first BSS is an OBSS relative to the second BSS.

Clause 26: A method for wireless communication by a first wireless AP, including: receiving one or more measurement reports from one or more wireless STAs, respectively, of a second BSS associated with a second wireless AP different than a first BSS associated with the first wireless AP, each measurement report including respective channel state information associated with a respective channel between the respective wireless STA associated with the measurement report and the first wireless AP; and transmitting, in accordance with the channel state information, a data packet to at least one wireless STA of the first BSS, the method further including transmitting, using a first transmission power, a first portion of the data packet with or without applying an interference reduction scheme to each respective channel between each of at least a subset of the one or more wireless STAs and the first wireless AP in accordance with the respective channel state information associated with the respective channel; and transmitting, using a second transmission power, a second portion of the data packet in association with applying the interference reduction scheme to each respective channel between each of at least the subset of the one or more wireless STAs and the first wireless AP in accordance with the respective channel state information associated with the respective channel, the second transmission power being associated with an amount of time synchronization between first transmissions by the first wireless AP and second transmissions by the second wireless AP.

Clause 27: The method of clause 26, further including: receiving an indication of a guard interval duration used by the second wireless AP; and transmitting the second portion of the data packet using a relatively lower transmission power or a relatively higher transmission power in accordance with whether the guard interval duration used by the second wireless AP is greater than or equal to a threshold time duration, where the second transmission power is one of the relatively lower transmission power and the relatively higher transmission power.

Clause 28: The method of clause 27, where the threshold time duration is equal to a sum of a delay spread of a channel between the first wireless AP and the at least one wireless STA and a lag time between the first transmissions by the first wireless AP and the second transmissions by the second wireless AP.

Clause 29: The method of any of clauses 27 through 28, where the relatively lower transmission power is used for the second portion of the data packet if the guard interval duration is less than the threshold time duration and the relatively higher transmission power is used for the second portion of the data packet if the guard interval duration is greater than or equal to the threshold time duration.

Clause 30: The method of clause 29, where the guard interval duration is less than the threshold time duration, and the relatively lower transmission power is a function of one or more received signal strengths at each of the one or more wireless STAs associated with one or more transmissions by the first wireless AP.

Clause 31: The method of any of clauses 26 through 30, where the second transmission power is higher than the first transmission power in accordance with the interference reduction scheme being applied to the second portion of the data packet and being absent from the first portion of the data packet.

Clause 32: The method of any of clauses 26 through 31, where the first portion of the data packet is a non-beamformed portion of the data packet and the second portion of the data packet is a beamformed portion of the data packet, and the second portion is beamformed in accordance with the respective channel state information associated with each respective channel between each of at least the subset of the one or more wireless STAs and the first wireless AP.

Clause 33: The method of any of clauses 26 through 32, where the first BSS is an OBSS relative to the second BSS.

Clause 34: A first wireless AP for wireless communication, including one or more memories storing processor-executable code, and one or more processors coupled with the one or more memories and individually or collectively operable to execute the code to cause the first wireless AP to perform a method of any of clauses 1 through 25.

Clause 35: A first wireless AP for wireless communication, including a processing system that includes processor circuitry and memory circuitry that stores code, the processing system configured to cause the first wireless AP to perform a method of any of clauses 1 through 25.

Clause 36: A first wireless AP for wireless communication, including at least one means for performing a method of any of clauses 1 through 25.

Clause 37: A non-transitory computer-readable medium storing code for wireless communication, the code including instructions executable by one or more processors, individually or collectively, to perform a method of any of clauses 1 through 25.

Clause 38: A first wireless AP for wireless communication, including one or more memories storing processor-executable code, and one or more processors coupled with the one or more memories and individually or collectively operable to execute the code to cause the first wireless AP to perform a method of any of clauses 26 through 33.

Clause 39: A first wireless AP for wireless communication, including a processing system that includes processor circuitry and memory circuitry that stores code, the processing system configured to cause the first wireless AP to perform a method of any of clauses 26 through 33.

Clause 40: A first wireless AP for wireless communication, including at least one means for performing a method of any of clauses 26 through 33.

Clause 41: A non-transitory computer-readable medium storing code for wireless communication, the code including instructions executable by one or more processors, individually or collectively, to perform a method of any of clauses 26 through 33.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some examples be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A first wireless access point (AP), comprising:
a processing system that includes processor circuitry and memory circuitry that stores code, the processing system configured to cause the first wireless AP to:
transmit a set of sounding packets in accordance with a channel sounding operation at one or more wireless stations (STAs) of a second basic service set (BSS) associated with a second wireless AP different than a first BSS associated with the first wireless AP, the set of sounding packets being associated with one or more parameters indicative of the second BSS;
receive, in association with transmitting the set of sounding packets, one or more measurement reports from the one or more wireless STAs of the second BSS, respectively, each measurement report including respective channel state information associated with a respective channel between the respective wireless STA associated with the measurement report and the first wireless AP; and
transmit, in accordance with the channel state information, a data packet to at least one wireless STA of the first BSS.

2. The first wireless AP of claim 1, wherein each sounding packet of the set of sounding packets includes at least one parameter, of the one or more parameters, indicative of the second BSS.

3. The first wireless AP of claim 2, wherein the at least one parameter is associated with a value of a BSS color subfield, the value of the BSS color subfield being indicative of the second BSS.

4. The first wireless AP of claim 1, wherein the processing system is further configured to cause the first wireless AP to:
transmit a sounding announcement frame prior to transmitting the set of sounding packets, the sounding announcement frame including the one or more parameters indicative of the second BSS, wherein the set of sounding packets are associated with the one or more parameters in accordance with the sounding announcement frame including the one or more parameters.

5. The first wireless AP of claim 4, wherein the one or more parameters include a transmitter address associated with the sounding announcement frame, the transmitter address being indicative of the second wireless AP associated with the second BSS.

6. The first wireless AP of claim 1, wherein, to receive the one or more measurement reports, the processing system is further configured to cause the first wireless AP to:
monitor one or more second channels between the one or more wireless STAs, respectively, and the second wireless AP associated with the second BSS, wherein the one or more measurement reports are received via the one or more second channels, respectively.

7. The first wireless AP of claim 1, wherein the processing system is configured to cause the first wireless AP to:
receive the one or more measurement reports from the second wireless AP associated with the second BSS via a backhaul wireless communication link between the first wireless AP and the second wireless AP.

8. The first wireless AP of claim 1, wherein the processing system is further configured to cause the first wireless AP to:
exchange one or more coordination messages with the second wireless AP associated with the second BSS, wherein at least one of the one or more coordination messages is indicative of a time at which the second wireless AP is to transmit one or both of a sounding announcement frame and a beamforming report poll frame associated with the channel sounding operation, and wherein the set of sounding packets are transmitted by the first wireless AP subsequent to the time at which the second wireless AP is to transmit the sounding announcement frame, and wherein the set of sounding packets are transmitted by the first wireless AP prior to the time at which the second wireless AP is to transmit the beamforming report poll frame.

9. The first wireless AP of claim 1, wherein the processing system is further configured to cause the first wireless AP to:
transmit one or both of a sounding announcement frame and a beamforming report poll frame associated with the channel sounding operation, wherein the sounding announcement frame and the beamforming report poll frame are associated with one or more second parameters indicative of the second BSS, and wherein transmitting the set of sounding packets is in association with transmitting one or both of the sounding announcement frame and the beamforming report poll frame.

10. The first wireless AP of claim 9, wherein the one or more second parameters include a transmitter address associated with one or both of the sounding announcement frame and the beamforming report poll frame, the transmitter address being indicative of the second wireless AP associated with the second BSS.

11. The first wireless AP of claim 9, wherein the transmission of the set of sounding packets is in association with the transmission of the sounding announcement frame, and the reception of the one or more measurement reports is in association with the transmission of the beamforming report poll frame.

12. The first wireless AP of claim 9, wherein the processing system is further configured to cause the first wireless AP to:
receive information indicative of one or more association identifier (AID) values corresponding to the one or more wireless STAs of the second BSS; and
transmit one or both of the sounding announcement frame and the beamforming report poll frame in association with setting a transmitter address of one or both of the sounding announcement frame and the beamforming report poll frame to be indicative of the second wireless AP and including, in one or both of the sounding announcement frame and the beamforming report poll frame, the one or more AID values corresponding to the one or more wireless STAs of the second BSS, wherein the one or more second parameters that are indicative of the second BSS include the transmitter address indicative of the second wireless AP and the one or more AID values corresponding to the one or more wireless STAs of the second BSS.

13. The first wireless AP of claim 12, wherein the processing system is configured to cause the first wireless AP to:
receive an indication of each of the one or more AID values from the second wireless AP via a backhaul wireless communication link between the first wireless AP and the second wireless AP.

14. The first wireless AP of claim 12, wherein the processing system is configured to cause the first wireless AP to:
receive the information indicative of the one or more AID values via one or more sounding announcement frames transmitted by the second wireless AP in association with monitoring respective second channels between each of the one or more wireless STAs and the second wireless AP.

15. The first wireless AP of claim 1, wherein the processing system is configured to cause the first wireless AP to:
transmit the data packet in association with applying an interference reduction scheme to the respective channels between each of the one or more wireless STAs of the second BSS and the first wireless AP, wherein applying the interference reduction scheme to the respective channels is associated with the respective channel state information and a medium access control (MAC) address of each of the one or more wireless STAs.

16. The first wireless AP of claim 15, wherein the processing system is configured to cause the first wireless AP to:
set a precoder of the first wireless AP in accordance with the respective channel state information associated with the respective channels between each of the one or more wireless STAs and the first wireless AP, wherein the application of the interference reduction scheme is in association with the setting of the precoder.

17. The first wireless AP of claim 1, wherein the processing system is further configured to cause the first wireless AP to:
transmit, using a first transmission power, a first portion of the data packet with or without applying an interference reduction scheme to each respective channel between each of at least a subset of the one or more wireless STAs and the first wireless AP in accordance with the respective channel state information associated with the respective channel; and
transmit, using a second transmission power, a second portion of the data packet in association with applying the interference reduction scheme to each respective channel between each of at least the subset of the one or more wireless STAs and the first wireless AP in accordance with the respective channel state information associated with the respective channel, the second transmission power being associated with an amount of time synchronization between first transmissions by the first wireless AP and second transmissions by the second wireless AP.

18. The first wireless AP of claim 17, wherein the first portion of the data packet is a non-beamformed portion of the data packet and the second portion of the data packet is a beamformed portion of the data packet, and wherein the second portion is beamformed in accordance with the respective channel state information associated with each respective channel between each of at least the subset of the one or more wireless STAs and the first wireless AP.

19. The first wireless AP of claim 17, wherein the processing system is further configured to cause the first wireless AP to:
receive an indication of a guard interval duration used by the second wireless AP; and
transmit the second portion of the data packet using a relatively lower transmission power or a relatively higher transmission power in accordance with whether the guard interval duration used by the second wireless AP is greater than or equal to a threshold time duration, wherein the second transmission power is one of the relatively lower transmission power and the relatively higher transmission power.

20. A first wireless access point (AP), comprising:
a processing system that includes processor circuitry and memory circuitry that stores code, the processing system configured to cause the first wireless AP to:
receive one or more measurement reports from one or more wireless STAs, respectively, of a second basic service set (BSS) associated with a second wireless AP different than a first BSS associated with the first wireless AP, each measurement report including respective channel state information associated with a respective channel between the respective wireless STA associated with the measurement report and the first wireless AP; and
transmit, in accordance with the channel state information, a data packet to at least one wireless STA of the first BSS, the processing system being configured to cause the first wireless AP to:
transmit, using a first transmission power, a first portion of the data packet with or without applying an interference reduction scheme to each respective channel between each of at least a subset of the one or more wireless STAs and the first wireless AP in accordance with the respective channel state information associated with the respective channel; and
transmit, using a second transmission power, a second portion of the data packet in association with applying the interference reduction scheme to each respective channel between each of at least the subset of the one or more wireless STAs and the first wireless AP in accordance with the respective channel state information associated with the respective channel, the second transmission power being associated with an amount of time synchronization between first transmissions by the first wireless AP and second transmissions by the second wireless AP.

21. The first wireless AP of claim 20, wherein the processing system is further configured to cause the first wireless AP to:
receive an indication of a guard interval duration used by the second wireless AP; and
transmit the second portion of the data packet using a relatively lower transmission power or a relatively higher transmission power in accordance with whether the guard interval duration used by the second wireless AP is greater than or equal to a threshold time duration, wherein the second transmission power is one of the relatively lower transmission power and the relatively higher transmission power.

22. The first wireless AP of claim 21, wherein the relatively lower transmission power is used for the second portion of the data packet if the guard interval duration is less than the threshold time duration and the relatively higher transmission power is used for the second portion of the data packet if the guard interval duration is greater than or equal to the threshold time duration.

23. The first wireless AP of claim 20, wherein the second transmission power is higher than the first transmission power in accordance with the interference reduction scheme being applied to the second portion of the data packet and being absent from the first portion of the data packet.

24. The first wireless AP of claim 20, wherein the first portion of the data packet is a non-beamformed portion of the data packet and the second portion of the data packet is a beamformed portion of the data packet, and the second portion is beamformed in accordance with the respective channel state information associated with each respective channel between each of at least the subset of the one or more wireless STAs and the first wireless AP.

25. A method for wireless communication by a first wireless access point (AP), comprising:
transmitting a set of sounding packets in accordance with a channel sounding operation at one or more wireless stations (STAs) of a second basic service set (BSS) associated with a second wireless AP different than a first BSS associated with the first wireless AP, the set of sounding packets being associated with one or more parameters indicative of the second BSS;
receiving, in association with transmitting the set of sounding packets, one or more measurement reports from the one or more wireless STAs of the second BSS, respectively, each measurement report including respective channel state information associated with a respective channel between the respective wireless STA associated with the measurement report and the first wireless AP; and
transmitting, in accordance with the channel state information, a data packet to at least one wireless STA of the first BSS.

26. The method of claim 25, wherein each sounding packet of the set of sounding packets includes at least one parameter, of the one or more parameters, indicative of the second BSS.

27. The method of claim 25, further comprising:
transmitting a sounding announcement frame prior to transmitting the set of sounding packets, the sounding announcement frame including the one or more parameters indicative of the second BSS, wherein the set of sounding packets are associated with the one or more parameters in accordance with the sounding announcement frame including the one or more parameters.

28. The method of claim 25, further comprising:
receiving an indication of one or more received signal strengths at each of the one or more wireless STAs associated with one or more transmissions by the first wireless AP; and
transmitting the data packet using a transmission power that is selected in accordance with whether the one or more received signal strengths satisfy a threshold received signal strength.

29. A method for wireless communication by a first wireless access point (AP), comprising:
receiving one or more measurement reports from one or more wireless STAs, respectively, of a second basic service set (BSS) associated with a second wireless AP different than a first BSS associated with the first wireless AP, each measurement report including respective channel state information associated with a respective channel between the respective wireless STA associated with the measurement report and the first wireless AP; and
transmitting, in accordance with the channel state information, a data packet to at least one wireless STA of the first BSS, the method further comprising:
transmitting, using a first transmission power, a first portion of the data packet with or without applying an interference reduction scheme to each respective channel between each of at least a subset of the one or more wireless STAs and the first wireless AP in accordance with the respective channel state information associated with the respective channel; and
transmitting, using a second transmission power, a second portion of the data packet in association with applying the interference reduction scheme to each respective channel between each of at least the subset of the one or more wireless STAs and the first wireless AP in accordance with the respective channel state information associated with the respective channel, the second transmission power being associated with an amount of time synchronization between first transmissions by the first wireless AP and second transmissions by the second wireless AP.

30. The method of claim 29, further comprising:
receiving an indication of a guard interval duration used by the second wireless AP; and
transmitting the second portion of the data packet using a relatively lower transmission power or a relatively higher transmission power in accordance with whether the guard interval duration used by the second wireless AP is greater than or equal to a threshold time duration, wherein the second transmission power is one of the relatively lower transmission power and the relatively higher transmission power.
